(19) United States
(12) Patent Application Publication
(10) Pub. No.: US 2014/0372513 A1
(43) Pub. Date: Dec. 18, 2014

(54) MULTI-TENANT ENABLING A SINGLE-TENANT COMPUTER PROGRAM PRODUCT

(71) Applicant: CloudVu, Inc., Sandy, UT (US)

(72) Inventor: Bradley W. Jones, Centerville, UT (US)

(73) Assignee: CloudVu, Inc., Sandy, UT (US)

(21) Appl. No.: 14/014,322

(22) Filed: Aug. 29, 2013

Related U.S. Application Data
(60) Provisional application No. 61/834,204, filed on Jun. 12, 2013.

(51) Int. Cl. H04L 29/08

(52) U.S. Cl. CPC H04L 67/10
USPC 709/203

(57) ABSTRACT

Apparatuses, systems, methods, and computer program products are disclosed for multi-tenant enabling a single-tenant computer program product. A layer communication gateway module may tag data associated with multiple tenants. A common repository module may provide the data to a single-tenant computer program product. A user interface gateway module may present a user interface for the computer program product to a single tenant based on one or more tags associated with the single tenant.

### CROSS-REFERENCES TO RELATED APPLICATIONS

This application claims the benefit of U.S. Provisional Patent Application No. 61/834,204 entitled “METHOD FOR CLOUD ENABLING EXISTING SOFTWARE USING A GATEWAY APPROACH ON A MULTI-TENANT PLATFORM” and filed on Jun. 12, 2013, for Bradley W. Jones, which is incorporated herein by reference.

### BACKGROUND

1. Field of the Invention

The present disclosure, in various embodiments, relates to multitenancy and more particularly relates to multi-tenant enabling a single-tenant computer program product.

2. Description of the Related Art

In general, single-tenancy refers to a situation where a single tenant, which may be a user or an entity, uses a dedicated software application. For example, on-premise software applications are traditionally single-tenant applications. Multitenancy, on the other hand, usually refers to a single instance of a software application that serves multiple tenants. Multi-tenant architectures may provide some advantages over single-tenant architectures, such as operational and cost efficiencies. Moreover, multitenancy may also be an important feature of cloud computing.

In general, the “cloud” describes a number of computers connected over a network, such as the Internet. Cloud computing is a term used to describe the computing opportunities that exist in the cloud, one of which may be “Software-as-a-Service” (SaaS). SaaS is a software solution where software applications and associated data may be stored in the cloud, which allows multiple users to access the software applications. SaaS solutions may be based on a multi-tenant architecture, which allows a single instance of the application to be used for multiple customers. Some software applications, however, may not be developed with this goal or architecture in mind.

### SUMMARY

From the foregoing discussion, it should be apparent that a need exists for an apparatus, system, and method to multi-tenant enable a single-tenant computer program product. Beneficially, such an apparatus, system, and method would allow a natively single-tenant computer program product to be executed as a service so that the computer program product may be accessed by multiple tenants.

The present disclosure has been developed in response to the present state of the art, and in particular, in response to the problems and needs in the art that have not yet been fully solved by currently available machine learning methods. Accordingly, the present disclosure has been developed to provide an apparatus, system, and method for multi-tenant enabling a single-tenant computer program product that overcome many or all of the above-discus sed shortcomings in the art.

Apparatuses are presented for multi-tenant enabling a single tenant computer program product. In one embodiment, a layer communication gateway module is configured to tag data associated with multiple tenants. In a further embodiment, a tag is uniquely associated with a tenant. A common repository module, in another embodiment, is configured to provide the data to a single-tenant computer program product. In one embodiment, the data is associated with the multiple tenants. In certain embodiments, a user interface gateway module is configured to present a user interface for the computer program product to a single tenant based on one or more tags associated with the single tenant.

Methods are presented for multi-tenant enabling a single tenant computer program product. In one embodiment, a method includes tagging data associated with multiple tenants. In another embodiment, a tag is uniquely associated with a tenant. A method, in certain embodiments, includes providing the data to a single-tenant computer program product. In one embodiment, the data is associated with the multiple tenants. In another embodiment, a method includes presenting a user interface to a single tenant based on one or more tags associated with the single tenant.

Methods are presented for capturing data packets. A method, in one embodiment includes capturing, within a first computing device, data packets for the first computing device using a packet capturing module 212a executing on the first computing device. In one embodiment, the data packets include an identifier for a first destination. In a further embodiment, a method includes encapsulating the captured data packets with a packet header that includes an identifier for a second destination associated with a second computing device. In certain embodiments, a method includes sending the encapsulated data packets to a packet receiving module executing on the second computing device. In one embodiment, the packet receiving module is configured to unencapsulate the encapsulated data packets and forward the unencapsulated data packets to a packet processing module associated with the first destination.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. The disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a multi-tenant enabling architecture for multi-tenant enabling a single-tenant computer program product;

FIG. 2 is a schematic block diagram illustrating one embodiment of a system for multi-tenant enabling a single-tenant computer program product;

FIG. 3 is a schematic block diagram illustrating one embodiment of another system for multi-tenant enabling a single-tenant computer program product;

FIG. 4 is a schematic block diagram illustrating one embodiment of a pattern recognition engine;

FIG. 5 is a schematic block diagram illustrating one embodiment of a multitenancy apparatus;

FIG. 6 is a schematic block diagram illustrating one embodiment of another multitenancy apparatus;

FIG. 7 is a schematic flow chart diagram illustrating one embodiment of a method for multi-tenant enabling a single-tenant computer program product;

FIG. 8 is a schematic flow chart diagram illustrating one embodiment of a method for presenting data to a user;

FIG. 9 is a schematic flow chart diagram illustrating one embodiment of a method for processing data using a pattern recognition engine;

FIG. 10 is a schematic flow chart diagram illustrating one embodiment of a method for receiving data from a monitoring agent; and

FIG. 11 is a schematic flow chart diagram illustrating one embodiment of a method for capturing data packets.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Aspects of the present invention are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

In certain embodiments, cloud solutions can be implemented in either a “Public” or “Private” cloud. In some embodiments, the private cloud solution is comprised of the software, platform, and infrastructure components that reside on an on-premise appliance located on the customer's internal network. In certain embodiments, this solution is ideal for customers that have security or bandwidth restrictions that require direct connectivity, or customers who are gently “easing” themselves into the cloud.

In some embodiments, the public cloud solution is comprised of components that may be distributed across many different physical machines and virtual platforms and are generally only accessible to the customer via the Internet. These are typically managed by a service provider with the equipment at their own site, a network operations center (NOC), or other data center.

Unlike traditional software, which may be conventionally sold with a perpetual license and an up-front cost (and an optional ongoing support fee), SaaS providers generally price applications using a subscription fee, most commonly a monthly or annual fee.

In one embodiment, the multi-tenant platform disclosed herein employs mature, third-party, natively single-tenant software, such as enterprise management software and re-delivers it as a cloud-based, managed service. In certain embodiments, these managed solutions can exist as either a dedicated, appliance-based “Private Cloud” or as a “Public Cloud” offering.

In one embodiment, the subject matter described herein delivers these Software solutions “as-a-Service” by providing the full functionality of the original software, with the convenience and cost effectiveness of using external resources to remotely host, configure, manage, and administer the desired application.

For example, the present disclosure may provide “Foglight-as-a-Service” (FaaS), or another third-party enterprise management software product that is developed to run natively as a single-tenant product, as a cloud-enabled, multi-tenant product implemented on the multi-tenant platform. In this example, Quest® Software's (a division of Dell®) Foglight® product (enterprise software for monitoring application performance, IT infrastructure, and networks) is re-deployed as a fully functional, subscription-based, managed service that is monitored and packaged within a turn-key, on-premise, dedicated appliance or non-dedicated, datacenter hosted hardware.

In one embodiment, an environment is created that provides managed services for a software product. In certain embodiments, an environment includes support hardware (infrastructure such as CPU, storage, networking, or the like) and software (platforms such as operating systems, servers, databases, or the like) that are managed in addition to managing the targeted single-tenant application software. This may imply knowledge of the single-tenant application software as well as the infrastructure and platform components and the interactions and dependencies between these components.

In one embodiment, the multi-tenant platform is designed to be a scalable, turnkey “Software-as-a-Service” (SaaS) management platform for enabling natively single-tenant, third-party software, such as enterprise management software. Each part of this disclosure may be remotely manageable as a service.

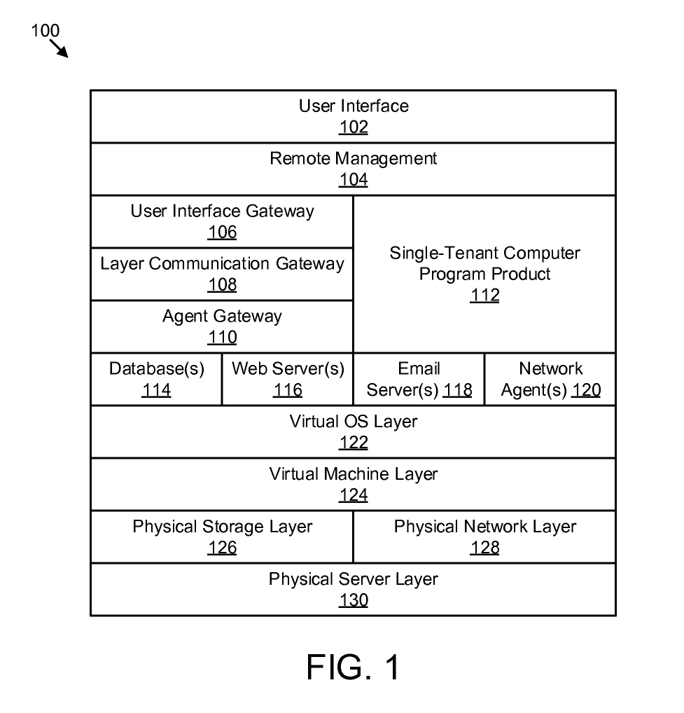

FIG. 1 depicts one embodiment of a multi-tenant enabling architecture 100 for multi-tenant enabling a single-tenant computer program product 112. In one embodiment, the multi-tenant enabling architecture 100 contains various infrastructure and platform components to enable the execution of natively single-tenant software 112 on a managed, multi-tenant platform 100. The multi-tenant enabling architecture 100, in various embodiments, facilitates customer use of enterprise software solutions in a non-dedicated, fully-automated, multi-tenanted environment hosted at a datacenter or other “public” location.

In one embodiment, the multi-tenant enabling architecture 100 allows multiple tenants to fully access all of the single-tenant software 112 features, while making it look and feel like it was customized for each individual tenant. In another embodiment, the multi-tenant enabling architecture 100 provides each tenant with its own data security, user interface dashboards, reports, settings, or the like. In certain embodiments, the multi-tenant platform 100 provides efficiency because it allows a single instance of the single-tenant software 112 to manage and support multiple customers or users, even though the single-tenant software 112 was not designed for native multi-tenant support. In one embodiment, the multi-tenant enabling architecture 100 solves scalability issues associated with multiple users requesting various data dashboard views (e.g., dashboards that monitor and analyze software or systems), which may traditionally be handled by brute force methods that involve complex bandwidth, routing, and communication links.

In one embodiment, the multi-tenant enabling architecture 100 provides a user interface layer 102, which presents a user interface to a tenant, locally using an electronic display device, remotely over a data network, or the like. The user interface layer 102, in some embodiments, provides various views of the single-tenant computer program product 112 and/or associated data to a user, which may include dashboards, reports, settings, or the like. In another embodiment, the user interface layer 102 allows the user interface to be customized for each individual user or tenant. Thus, even though there may be multiple users (e.g., tenants) accessing the single-tenant computer program product 112, the user interface may be customized to look and feel like it was designed specifically for each user, presenting only data, options, views, or the like associated with or owned by the specific user. The user interface layer 102, in further embodiments, provides user interfaces designed to be viewed on various displays, such as monitors, smart phone displays, tablet displays, or the like.

In certain embodiments, the multi-tenant enabling architecture 100 provides a remote management layer 104 that allows a user/tenant to remotely manage the single-tenant computer program product 112 and/or other layers of the architecture multi-tenant enabling 100 (e.g., over a data network, over the Internet, or the like). In some embodiments, the remote management layer 104 is accessible remotely through a user interface provided by the user interface layer 102. In one embodiment, the remote management layer 104 includes software and/or hardware configured to communicate over a data network and to provide users/tenants with remote access to the single-tenant computer program product 112. For example, the remote management layer 104 may provide access to the single-tenant computer program product 112 through a web browser, a command line interface, a remote access application, or the like. The remote management layer 104, in another embodiment, allows the user to configure a remotely-hosted single-tenant computer program product 112. For example, the computer program product 112 may be located on a server in the “cloud,” and the user may remotely access the computer program product 112, along with multiple other users or tenants, to access data, specify configuration or other settings, or the like, associated with the computer program product 112.

In one embodiment, the multi-tenant enabling architecture 100 provides different gateways 106, 108, 110, which facilitate collecting, sending, receiving, and/or distributing information for the single-tenant computer program product 112 across multiple sets of servers, engines, or the like. In certain embodiments, the multi-tenant enabling architecture 100 includes a user interface gateway 106 configured to present one or more customized user interfaces for the single-tenant computer program product 112 to different single tenants, such as the user interface 102 described above. In some embodiments, the user interface gateway 106 displays user interface views, such as data dashboards, reports, or the like.

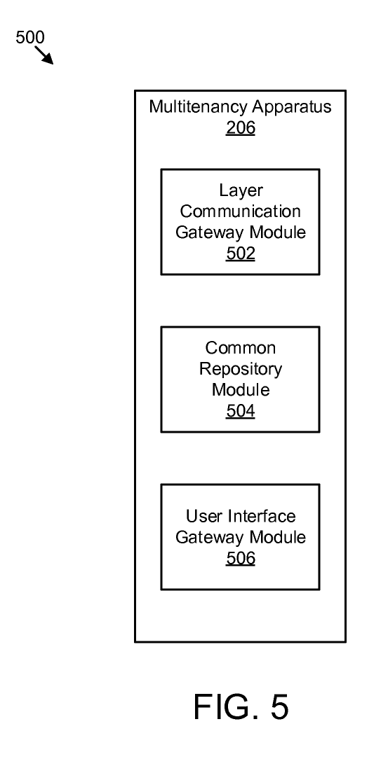

In certain embodiments, the user interface gateway 106 provides user interface views associated with a single-tenant enterprise management system 112, such as Foglight® products from Dell, Inc. of Round Rock, Tex.; OpenView® products from Hewlett-Packard Co. of Palo Alto, Calif.; Oracle Enterprise Manager from Oracle Corp. of Redwood City, Calif.; System Center Configuration Manager from Microsoft, Corp. of Redmond, Wash.; Tivoli Management Framework from International Business Machines Corp. of Armonk, N.Y.; ZENWorks® products from Novell, Inc. of Provo, Utah; Patrol® from BMC Software, Inc. of Houston, Tex.; or the like, which may provide alerts, warnings, system monitoring, enterprise management reports, or the like. In one embodiment, the user interface gateway 106 comprises or uses a user interface gateway module 506, which is described below with reference to FIG. 5, to perform the operations of the user interface gateway 106.

The single-tenant computer program product 112, in certain embodiments, may comprise an enterprise management system, an application performance management system, a configuration management system, a performance monitoring system, an incident management system, a business activity monitoring system, a business transaction management system, a network management system, a network monitoring system, or the like. An enterprise management system, in general, comprises software and/or hardware configured to administer, monitor, configure, or otherwise manage computing resources of a user or tenant. A computing resource, in various embodiments, may include a computing device, a component of a computing device (e.g., a processor, volatile memory, a nonvolatile storage device, a network interface or host adapter, a graphics processing unit or other graphics hardware, a power supply, or the like), a network device of a data network (e.g., a router, switch, bridge, gateway, hub, repeater, network-attached storage or NAS, proxy server, firewall, or the like), a software application or other computer executable code executing on a computing device (e.g., a server application, a database application, an operating system, a device driver, security or anti-virus software, or the like).

An enterprise management system (or an associated monitoring agent 212, as described below), in certain embodiments, may monitor enterprise management data for computing resources, computing devices, or the like of a user or tenant, allowing an enterprise management system to manage enterprise resources, provide alerts to a user or tenant, or the like. Enterprise management data, as used herein, comprises information, indicators, metrics, statistics, or other data associated with a user or tenant, a computing device or computing resource, a business, or the like. For example, in various embodiments, enterprise management data may include application log data, a monitored hardware statistic, a processor usage metric, a volatile memory usage metric, a storage device metric, a business event, an enterprise management event, a performance metric for a business activity, an identifier of an executing thread, a network event, a network metric, network data packets, a transaction duration, a user sentiment indicator, a weather status for a geographic area of the one or more computing resources, or the like.

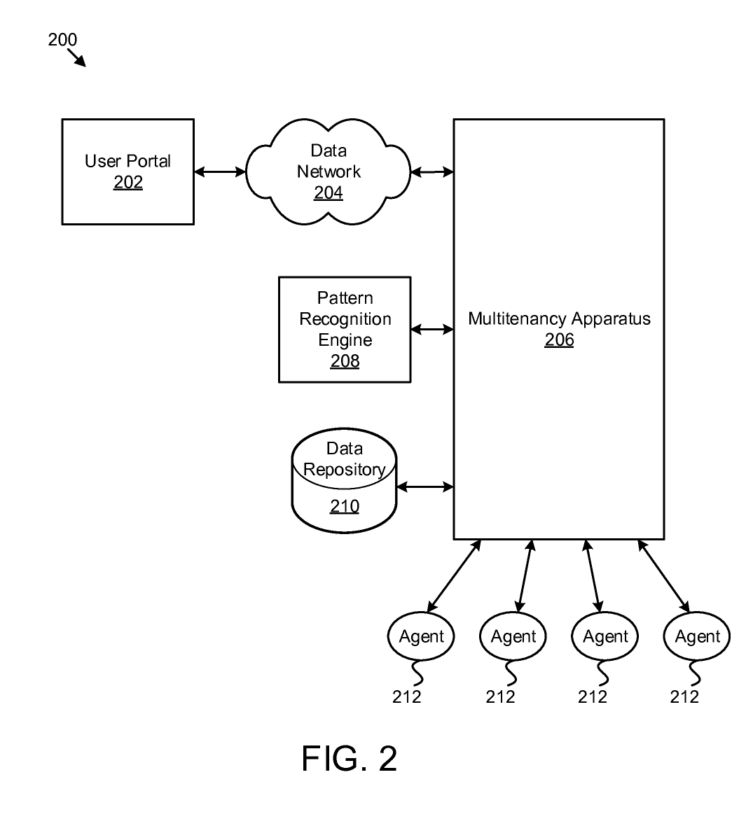

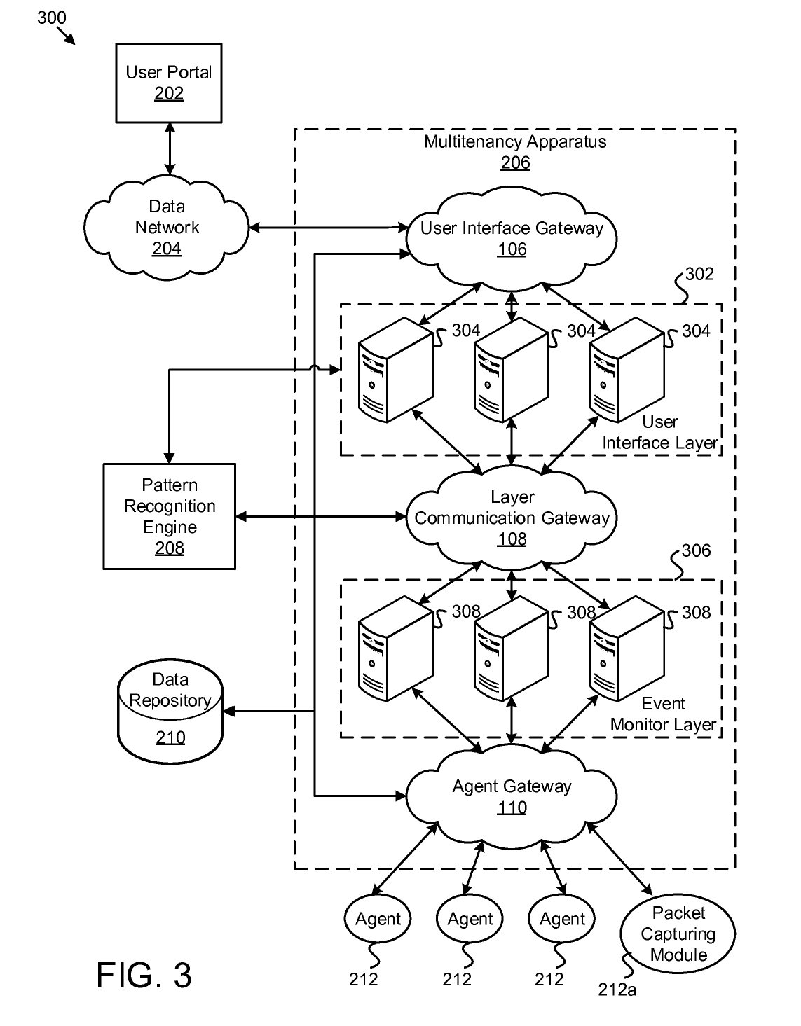

In another embodiment, the multi-tenant enabling architecture 100 includes a layer communication gateway 108 configured to tag data associated with multiple tenants using the single-tenant computer program product 112. The data, in certain embodiments, may be tagged with a tag that is unique to a single tenant, so that data associated with one tenant is not accessible to another tenant. In one embodiment, the layer communication gateway 108 facilitates and/or controls the flow of information to and/or from various servers, networks, data repositories, or the like. In some embodiments, the layer communication gateway 108 sends data to a pattern recognition engine 208 to be analyzed and/or processed, as described below with reference to FIG. 2. In a further embodiment, tagged data is stored in a common data repository 210 (e.g., the one or more databases 114 or the like), where it may be retrieved by the layer communication gateway 108 and forwarded to various locations, including one or more servers 340 associated with the user interface gateway 106, as described below with reference to FIG. 3. In one embodiment, the layer communication gateway 108 uses a layer communication gateway module 502, which is described below with reference to FIG. 5, to perform the operations of the layer communication gateway 108.

In one embodiment, the multi-tenant enabling architecture 100 includes an agent gateway 110 configured to forward data from one or more monitoring agents 212 to one or more monitoring servers 308 executing the single-tenant computer program product 112, as described below with reference to FIG. 2 and FIG. 3. In some embodiments, the agent gateway 110 receives or accepts monitoring agent communications from one or more monitoring agents 212. A monitoring agent 212, as used herein, comprises a software and/or hardware module (e.g., an enterprise management system, a packet capturing module, a software driver, a network appliance, a dedicated or special purpose computing device, or the like) configured to monitor or collect data, such as enterprise management data, application log data, a monitored hardware statistic, a processor usage metric, a volatile memory usage metric, a storage device metric, a business event, an enterprise management event, a performance metric for a business activity, an identifier of an executing thread, a network event, a network metric, network data packets, a transaction duration, a user sentiment indicator, a weather status for a geographic area of the one or more computing resources, or the like. Monitoring agents 212 may be disposed on different computing devices from the agent gateway 110, and may communicate with the agent gateway 110 over a data network, may be collocated with the agent gateway 110 on the same computing device, or the like.

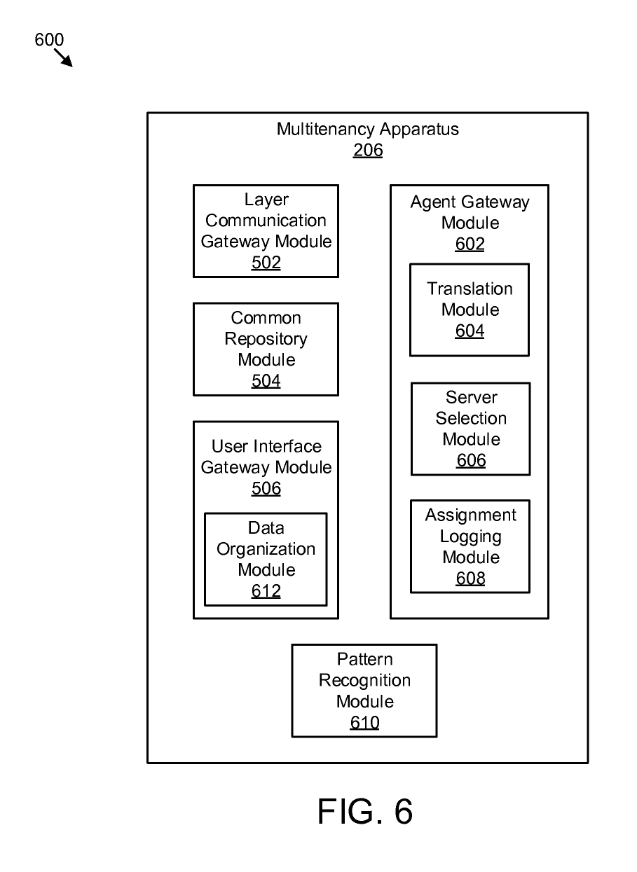

In some embodiments, the agent gateway 110 dynamically assigns a monitoring agent 212 to one or more monitoring servers 308 so that data is forwarded from the monitoring agent 212 to the one or more assigned monitoring servers 308. In certain embodiments, the agent gateway 110 receives event data from a monitoring agent 212 associated with an enterprise management single-tenant computer program product 112, such as Foglight®, OpenView®, Oracle Enterprise Manager, System Center Configuration Manager, Tivoli Management Framework, ZENWorks®, Patrol®, or the like. In a further embodiment, the agent gateway 110 comprises or uses an agent gateway module 602, which is described below with reference to FIG. 6, to perform the operations of the agent gateway 110.

In some embodiments, the user interface gateway 106, the layer communication gateway 108, and the agent gateway 110 store and/or retrieve data from one or more servers in a way that ensures, for example, a secure session, a “single sign-on” interface, and/or access to customer-specific data that has been prepared to be accessed by each gateway 106, 108, 110. In some embodiments, the multi-tenant enabling architecture 100 comprises a tiered gateway approach designed with an entry point for multi-tenant enabling single-tenant enterprise management software and a separate entry point for multi-tenant enabling general single-tenant applications.

The single-tenant computer program product 112, in one embodiment, is a computer program product that is natively designed to be used by a single tenant. In some embodiments, this means that a single instance of a software application, and the supporting infrastructure, serves a single user. For example, the single-tenant computer program product 112 may include an application monitoring software program, such as Foglight®, OpenView®, Oracle Enterprise Manager, System Center Configuration Manager, Tivoli Management Framework, ZENWorks®, Patrol®, or the like, that generally may be customized to meet the specific enterprise management or monitoring needs of a single tenant.

The multi-tenant enabling architecture 100, however, may multi-tenant enable the single-tenant computer program product 112 using one or more of the gateways 106, 108, 110, so that multiple tenants may utilize a single instance of the computer program product 112. In this manner, the single-tenant computer program product 112 may appear to be customized for a single tenant, while being accessed by multiple users. In certain embodiments, the multi-tenant enabling architecture 100 may comprise multiple instances of the single-tenant computer program product 112, each of which the multi-tenant enabling architecture 100 may enable for use with multiple tenants.

In a further embodiment, the multi-tenant enabling architecture 100 includes one or more databases 114 configured to store data associated with multiple tenants using the single-tenant computer program product 112. In some embodiments, the one or more databases 114 stores tagged data associated with multiple tenants. In certain embodiments, the one or more databases 114 include a common data repository 210, as described below with reference to FIG. 2, which stores tagged and/or raw data associated with multiple users.

In another embodiment, the multi-tenant enabling architecture 100 includes one or more web servers 116 configured to deliver content, such as data associated with the multiple tenants, dashboards, reports, or the like, that can be accessed through a data network, such as the Internet, in cooperation with the user interface 102, the remote management layer 104, and/or the user interface gateway 106 as described above. The one or more web-servers 116 may include Apache Software Foundation's Apache HTTP Server, Microsoft's® Internet Information Services, or the like.

In one embodiment, the multi-tenant enabling architecture 100 includes one or more email servers 118 configured to store, receive, and/or send emails associated with one or more users/tenants. The one or more email servers 118 may send and/or receive email communications in cooperation with the user interface 102, the remote management layer 104, and/or the user interface gateway 106 as described above.

In another embodiment, the multi-tenant enabling architecture 100 includes one or more network agents 120 configured to provide communication between elements of the multi-tenant enabling architecture 100 (e.g., the remote management layer 104, the user interface gateway 106, the layer communication gateway 108, the agent gateway 110, or the like) and one or more other computing devices over a data network, using the physical network layer 128. The one or more network agents 120, in certain embodiments, may provide network filtering, security, routing, logging, or the like.

Additionally, in certain embodiments, the multi-tenant enabling architecture 100 includes a virtual OS layer 122, which may execute on a virtual machine layer 124. For example, the virtual OS layer 122 may include an operating system such as a BSD, Linux®, OS X®, Unix®, Windows®, or other operating system executing on the virtual machine layer 124. The virtual machine layer 124 may emulate or virtualize the hardware of one or more computing devices, providing one or more virtual machines on which the operating systems of the virtual OS 122 may execute. The virtual machine layer 124 may provide software and/or hardware based virtualization, and may be native or hosted. In certain embodiments, the virtual machine layer 124 may comprise a hypervisor or virtual machine monitor configured to create and/or execute a plurality of virtual machines on the same physical storage layer 126, physical network layer 128, and/or physical server layer 130. In such embodiments, the multi-tenant enabling architecture 100 may execute within one or more virtual machines, sharing a host computing device with one or more additional virtual machines.

In one embodiment, the multi-tenant enabling architecture 100 includes a physical storage layer 126 that includes one or more computer readable storage media (e.g., a hard drive or other magnetic storage, optical storage, solid-state storage, volatile memory, or the like) for storing data of the multi-tenant enabling architecture. In another embodiment, the multi-tenant enabling architecture 100 includes a physical network layer 128 that includes one or more physical network interfaces, such as wired and/or wireless networking logic devices. In a further embodiment, the multi-tenant enabling architecture 100 includes a physical server layer 130, which includes the CPU, memory, firmware, BIOS, or the like of a host computing device. While the multi-tenant enabling architecture 100 is depicted with specific examples of software and hardware, in other embodiments, the multi-tenant enabling architecture 100 may not include one or more of the depicted elements. For example, the multi-tenant enabling architecture 100 may comprise or execute on a server or other computing device without a virtual OS layer 122 and virtual machine layer 124 or the like.

FIG. 2 depicts one embodiment of a system 200 for multi-tenant enabling a single-tenant computer program product 112. In one embodiment, the system 200 includes a user portal 202, a data network 204, a multitenancy apparatus 206, a pattern recognition engine 208, a data repository 210, and one or more monitoring agents 212, which are described below in greater detail.

The system 200, in one embodiment, includes a user portal 202 configured to provide a user access to the single-tenant computer program product 112. In some embodiments, the user portal 202 accesses the single-tenant computer program product 112 through the data network 204. In one embodiment, the user provides one or more login credentials to access the single-tenant computer program product 112. In certain embodiments, the user portal 202 communicates with the user interface gateway 106 in order to retrieve the information to be displayed to the user.

The user portal 202, in another embodiment, may include a computing device, such as a server, a desktop computer, a laptop computer, a tablet, a smart device, or the like. In certain embodiments, the user portal 202 includes application software that allows a user to configure settings associated with the user of the single-tenant computer program product 112, such as remote access software, a web browser, a file transfer program, or the like. In one embodiment, the user portal 202 combines multiple user interface components requiring different login credentials into a single user interface view so that a user only has to provide a single set of login credentials to access the user interface components.

In another embodiment, the system 200 includes a data network 204. The data network 204, in certain embodiments, is a digital communication network 204 that transmits digital communications related to multi-tenant enabling a single-tenant computer program product 112. The data network 204 may include a wireless network, such as a wireless telephone network, a local wireless network, such as a Wi-Fi network, a Bluetooth® network, a near field communication (NFC) connection, and the like. The data network 204 may include a wide area network (WAN), a storage area network (SAN), a local area network (LAN), an optical fiber network, the Internet, or other digital communication network known in the art. The data network 204 may include two or more networks. The data network 204 may include one or more servers, routers, switches, and/or other networking equipment. The data network 204 may also include computer readable storage media, such as a hard disk drive, an optical drive, non-volatile memory, random access memory (RAM), or the like.

In one embodiment, the system 200 includes a multitenancy apparatus 206 configured to multi-tenant enable a single-tenant computer program product 112. For example, the multitenancy apparatus 206 may allow multiple users to execute a single instance of a software application natively developed to be executed by a single user. In certain embodiments, and as described below in greater detail with reference to FIGS. 5 and 6, the multitenancy apparatus 206 includes one or more gateways 106, 108, 110, that facilitate multi-tenant enabling a single-tenant computer program product 112.

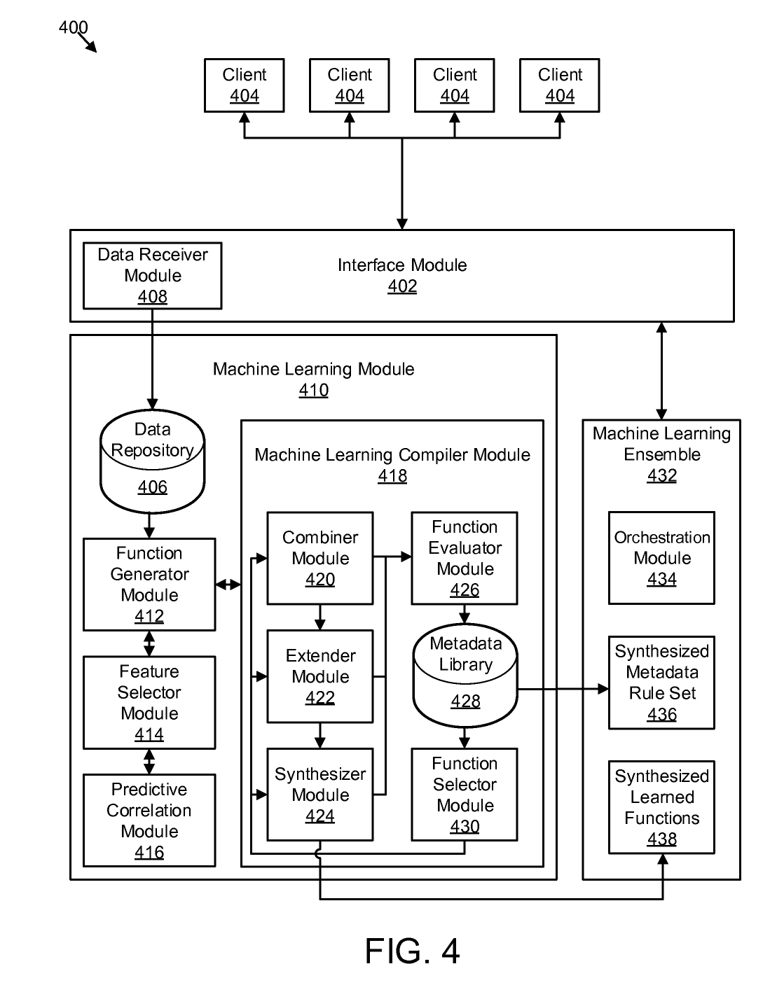

The system 200, in certain embodiments, includes a pattern recognition engine 208 configured to perform pattern analysis on the data associated with multiple tenants, using machine learning. In certain embodiments, the pattern recognition engine 208 receives data from a monitoring agent 212, the data repository 210, a gateway 106, 108, 110, or the like. The pattern recognition engine 208, in some embodiments, outputs machine learning results for viewing in the user portal 202. The machine learning results, in certain embodiments, may include a classification, a confidence metric, an inferred function, a regression function, an answer, a prediction, a recognized pattern, a rule, a recommendation, an evaluation, a setting, a threshold, a configuration, or the like associated with data from one or more monitoring agents 212, with data of the single-tenant computer program product 112, or the like. The pattern recognition engine 208 is described in greater detail below with reference to FIGS. 3 and 4.

In another embodiment, the system 200 includes a data repository 210 configured to store data associated with multiple tenants. The data repository 210 may include a database, such as a relational database, that may be queried in order to retrieve data from the data repository 210. The data repository 210, in one embodiment, stores data that has been tagged with a tag associated with a single tenant. In some embodiments, the data repository 210 stores data associated with a single tenant that has been processed by the pattern recognition engine 208. The gateways 106, 108, 110, in another embodiment, may have access to the data repository 210 and may store and/or retrieve data in the data repository 210.

In one embodiment, the system 200 includes one or more monitoring agents 212 configured to send data to the multitenancy apparatus 206. In one embodiment, a monitoring agent 212 includes an application that sends messages, data, or the like to the multitenancy apparatus 206. For example, the monitoring agents 212 may include different enterprise management system instances, such as Foglight®, OpenView®, Oracle Enterprise Manager, System Center Configuration Manager, Tivoli Management Framework, ZENWorks®, Patrol®, or the like, as described above. The one or more monitoring agents 212 may provide enterprise management data, application log data, a monitored hardware statistic, a processor usage metric, a volatile memory usage metric, a storage device metric, a business event, an enterprise management event, a performance metric for a business activity, an identifier of an executing thread, a network event, a network metric, network data packets, a transaction duration, a user sentiment indicator, a weather status for a geographic area of the one or more computing resources, or the like to the multitenancy apparatus 206.

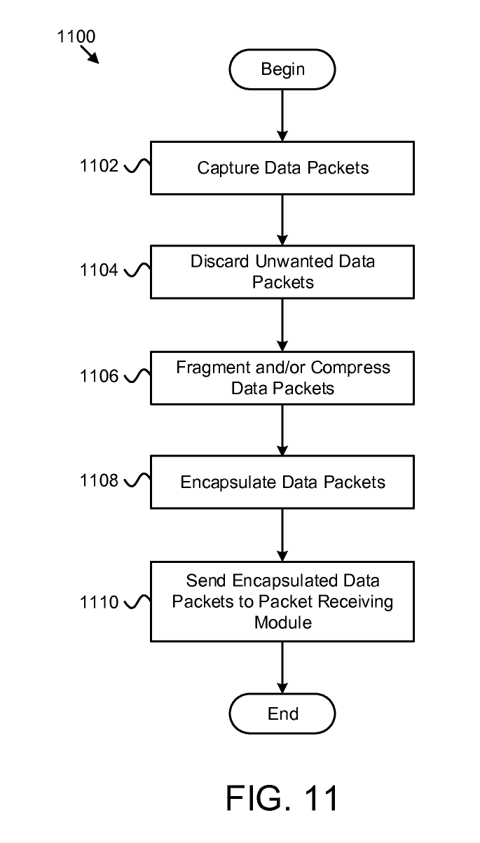

In the depicted embodiment, one of the monitoring agents 212 comprises a packet capturing module 212a. The packet capturing module 212a is described in greater detail below with regard to FIG. 11. Certain tenants or users may desire to monitor or sniff data packets on a data network. For example, a tenant or user may provide e-commerce using a web server 116 and may use the packet capturing module 212a to monitor data packets for analysis, a tenant or user may use the packet capturing module 212a to monitor data packets for a computing device on a local network, a tenant or user may use the packet capturing module 212a to provide web analytics, or the like. The packet capturing module 212a may forward data packets to the multitenancy apparatus 206 (e.g., to the agent gateway 110, the agent gateway module 602 described below, or the like) located on a different computing device.

In certain embodiments, a tenant or user may use third party, shared, hosted, and/or public cloud computing resources, such as a third party server or hosting platform at a data center or the like. In such embodiments, a tenant or user may not have direct access to a data network, network hardware or components, or the like from which to collect data packets. For example, a third party service provider owning or managing shared, hosted, and/or public cloud computing resource may deny, block, or fail to grant access to a data network and/or network devices, for security purposes, privacy purposes, or the like.

The packet capturing module 212a may provide access to data packets remotely, without direct physical access to a data network or network hardware itself. For example, in one embodiment, the packet capturing module 212a may be installed as or cooperate with a driver on a computing device, within a virtual machine, or the like, and may forward data packets sent to and/or from the computing device, the virtual machine, or the like. In certain embodiments, because the packet capturing module 212a may comprise executable code installed on a computing device, a virtual machine, or the like, and may only have access to data packets sent to or from the computing device, virtual machine, or the like, preserving the security and/or privacy of other tenants or users using the third party, shared, hosted, and/or public cloud computing resources. In this manner, the packet capturing module 212a may provide data packets from a remote computing device and/or virtual machine for analysis or processing at a different location (e.g., by the multitenancy apparatus 206, the single-tenant computer program product 112, a web analytics system, a packet analyzer, a network analyzer, a protocol analyzer, or the like).

In certain embodiments, the agent gateway 110 receives the messages sent from a monitoring agent 212 and translates the messages into a default monitoring nomenclature (e.g., a nomenclature associated with the single-tenant computer program product 112). For example, the multitenancy apparatus 206, in particular the agent gateway 110, may translate messages from a monitoring agent 212 running an instance of IBM's® Tivoli to a format that may be read by a single-tenant Foglight® instance, or the like. In some embodiments, each monitoring agent 212 includes a different application and each monitoring agent 212 sends different messages based on the application being executed.

FIG. 3 depicts one embodiment of another system 300 for multi-tenant enabling a single-tenant computer program product 112. In one embodiment, the system 300 includes a user interface gateway 106, a communication gateway 108, and an agent gateway 110, which are substantially similar to the user interface gateway 106, communication gateway 108, and agent gateway 110 described with reference to FIG. 1. In another embodiment, the system 300 includes a user portal 202, a data network 204, a multitenancy apparatus 206, a pattern recognition engine 208, a data repository 210, and one or more monitoring agents 212, which are substantially similar to the user portal 202, data network 204, multitenancy apparatus 206, pattern recognition engine 208, data repository 210, and one or more monitoring agents 212 described with reference to FIG. 2. In a further embodiment, the system 300, in particular the multitenancy apparatus 206, includes a user interface layer 302, which includes one or more user interface servers 304, and an event monitor layer 306, which includes one or more monitoring servers 308. These components of the system 300 are described below in greater detail.

In one embodiment, the system 300 includes a user interface layer 302 that includes one or more user interface servers 304. The user interface servers 304, in another embodiment, may include a server, a blade center, a mainframe, a desktop computer, a laptop computer, or the like. In certain embodiments, the one or more user interface servers 304 are in communication with a user interface gateway 106 and a communication gateway 108. The user interface servers 304, in certain embodiments, store user interface data associated with multiple tenants. In some embodiments, the user interface servers 304 create one or more user interface components based on the user interface data associated with the multiple tenants, such as dashboards, gauges, reports, charts, graphs, tables, or the like.

In some embodiments, the user interface servers 304 store tagged user interface data, which may be accessed by providing the tag (e.g., a unique identifier, a customer number, or the like) associated with the user interface data. In some embodiments, the tag is associated with a single tenant, to identify, mark, or otherwise associate each different tenant with its associated data. Thus, user interface data associated with a single tenant may be accessed by providing the tag associated with the single tenant. In this manner, the multitenancy apparatus 206 may present user interface data associated with a single tenant without exposing data associated with one or more different tenants.

In certain embodiments, the user interface servers 304 retrieve user interface data based on credentials provided by the user. In some embodiments, the tag associated with a user is based on or determinable from one or more credentials provided by the user. For example, the tag may include the user name provided by the user. In another example, the tag may include a hash of a user name and the password. In one embodiment, the tag may include a unique random string of characters. In certain embodiments, the user enters credentials in the user portal 202, which sends the credentials to the user interface gateway 106 through the data network 204.

In a further embodiment, the user interface gateway 106 retrieves data from the data repository 210 to determine the user interface servers 304 storing user interface data associated with a user. In some embodiments, the user interface gateway 106 queries a database located on the data repository 210 to determine which user interface servers 304 store user interface data associated with the user. In certain embodiments, the user interface gateway 106 looks up the user interface server 304 information in the data repository 210 using one or more of the credentials and the tag as a key. In one embodiment, the data repository 210 stores one or more tags associated with the user, which the user interface gateway 106 may use, together with the information regarding the location of the user interface data, to retrieve the user interface data from the one or more user interface servers 304.

In certain embodiments, the user interface gateway 106 retrieves pattern recognition data from the pattern recognition engine 208. In some embodiments, the pattern recognition data is stored on an internal data store associated with the pattern recognition engine 208, such as a database. The user interface gateway 106 may incorporate pattern recognition data into one or more user interface components, which may be stored in one or more user interface servers 304. The pattern recognition engine 208 is described below in greater detail with reference to FIG. 4.

In one embodiment, the system 300 includes an event monitor layer 306 that includes one or more monitoring servers 308. The one or more monitoring servers 308, in another embodiment, may include a server, a blade center, a mainframe, a desktop computer, a laptop computer, or the like. In certain embodiments, the monitoring servers 308 are in communication with a layer communication gateway 108 and an agent gateway 110. In further embodiments, an instance of the single-tenant computer program product 112 executes on each of the one or more monitoring servers 308. In some embodiments, the single-tenant computer program product 112 processes data received from the agent gateway 110. In certain embodiments, the monitoring servers 308 store data received from the agent gateway 110 in a data store, such as a database.

In one embodiment, the agent gateway 110 associates one or more monitoring servers 308 with a single tenant and logs an assignment of a single tenant to one or more monitoring servers in the data repository 210. For example, the agent gateway 110 may store an identifier associated with the monitoring servers 308 assigned to a user in the data repository 210 so that other entities in the system (e.g., the layer communication gateway 108, the pattern recognition engine 208, or the like) may query the data repository 210 to determine which monitoring servers 308 store a user's data. In some embodiments, the monitoring servers 308 store data associated with multiple tenants. In one embodiment, the monitoring servers 308 store tagged data associated with a single tenant, so that a single tenant's data may be retrieved by providing a tag associated with the single tenant. In this manner, data associated with a user may be retrieved from the one or more monitoring servers 308 without exposing data associated with one or more different tenants.

In certain embodiments, the layer communication gateway 108 retrieves data associated with a user from one or more monitoring servers 308 based on one or more tags associated with the user and sends the data to one or more user interface servers 304, where it may be incorporated into one or more user interface components. In another embodiment, the layer communication gateway 108 retrieves data associated with a single tenant from one or more monitoring servers 308 and sends the data to a pattern recognition engine 208 to be processed and analyzed. The layer communication gateway 108, in a further embodiment, may store outputted data from the pattern recognition engine 208 in a data repository 210. In certain embodiments, the monitoring servers 308 may communicate directly with the user interface gateway 106 in order to send messages directly to a user, which may include sending alert messages, event messages, or the like.

In one embodiment, the tiered gateway approach of the multitenancy apparatus 206 allows multiple tenants to execute a single instance of a single-tenant computer program product 112. However, the multitenancy apparatus 206 allows a single tenant to access and/or customize data, settings, configurations, or the like, associated with the single-tenant computer program product 112 so that it appears the single tenant is the only user of the single-tenant computer program product 112, even though multiple users may be executing the same instance of the single-tenant computer program product 112. Further, by tagging the data with a unique tag associated with a single tenant, the multitenancy apparatus 206 may provide data isolation and security so that the single tenant may only have access to his data and not to other tenant's data that may be stored on one or more of the same servers 304, 308. In one embodiment, one or more modules may perform one or more operations of the multitenancy apparatus 206, which are described below with reference to FIGS. 5 and 6.

FIG. 4 depicts one embodiment of a pattern recognition engine 400, which may be substantially similar to the pattern recognition engine 208 described above. In some embodiments, the pattern recognition engine 400 includes an interface module 402 and a machine learning module 410. In the depicted embodiment, the machine learning module 410 includes a data repository 406, a data receiver module 408, a function generator module 412, a machine learning compiler module 418, a feature selector module 414, a predictive correlation module 416, and a machine learning ensemble 432. The machine learning compiler module 418, in the depicted embodiment, includes a combiner module 420, an extender module 422, a synthesizer module 424, a function evaluator module 426, a metadata library 428, and a function selector module 430. The machine learning ensemble 432, in the depicted embodiment, includes an orchestration module 434, a synthesized metadata rule set 436, and synthesized learned functions 438.

The data receiver module 408, in certain embodiments, is configured to receive client data, such as training data, test data, workload data, or the like, from a client 404, which may include a layer communication gateway 108, an agent gateway 110, or the like, either directly or indirectly. The data receiver module 408, in various embodiments, may receive data over a local channel such as an API, a shared library, a hardware command interface, or the like; over a data network such as wired or wireless LAN, WAN, the Internet, a serial connection, a parallel connection, or the like. In certain embodiments, the data receiver module 408 may receive data indirectly from a client 404, or the like, through an intermediate module that may pre-process, reformat, or otherwise prepare the data for the machine learning module 410. The data receiver module 408 may support structured data, unstructured data, semi-structured data, or the like.

One type of data that the data receiver module 408 may receive, as part of a new ensemble request or the like, is initialization data. The machine learning module 410, in certain embodiments, may use initialization data to train and test learned functions from which the machine learning module 410 may build a machine learning ensemble 432. Initialization data may comprise historical data, statistics, Big Data, customer data, marketing data, computer system logs, computer application logs, data networking logs, or other data that a client 404 provides to the data receiver module 408 with which to build, initialize, train, and/or test a machine learning ensemble 432.

Another type of data that the data receiver module 408 may receive, as part of an analysis request or the like, is workload data. The machine learning module 410, in certain embodiments, may process workload data using a machine learning ensemble 432 to obtain a result, such as a classification, a confidence metric, an inferred function, a regression function, an answer, a prediction, a recognized pattern, a rule, a recommendation, an evaluation, a setting, a threshold, a configuration, or the like. Workload data for a specific machine learning ensemble 432, in one embodiment, has substantially the same format as the initialization data used to train and/or evaluate the machine learning ensemble 432. For example, initialization data and/or workload data may include one or more features. As used herein, a feature may comprise a column, category, data type, attribute, characteristic, label, or other grouping of data. For example, in embodiments where initialization data and/or workload data that is organized in a table format, a column of data may be a feature. Initialization data and/or workload data may include one or more instances of the associated features. In a table format, where columns of data are associated with features, a row of data is an instance.

In one embodiment, the data receiver module 408 may maintain client data, such as initialization data and/or workload data, in a data repository 406, where the function generator module 412, the machine learning compiler module 418, or the like may access the data. In certain embodiments, as described below, the function generator module 412 and/or the machine learning compiler module 418 may divide initialization data into subsets, using certain subsets of data as training data for generating and training learned functions and using certain subsets of data as test data for evaluating generated learned functions.

The function generator module 412, in certain embodiments, is configured to generate a plurality of learned functions based on training data from the data receiver module 408. A learned function, as used herein, comprises a computer readable code that accepts an input and provides a result. A learned function may comprise a compiled code, a script, text, a data structure, a file, a function, or the like. In certain embodiments, a learned function may accept instances of one or more features as input, and provide a result, such as a classification, a confidence metric, an inferred function, a regression function, an answer, a prediction, a recognized pattern, a rule, a recommendation, an evaluation, a setting, a threshold, a configuration, or the like. In another embodiment, certain learned functions may accept instances of one or more features as input, and provide a subset of the instances, a subset of the one or more features, or the like as an output. In a further embodiment, certain learned functions may receive the output or result of one or more other learned functions as input, such as a Bayes classifier, a Boltzmann machine, or the like.

The function generator module 412 may generate learned functions from multiple different machine learning classes, models, or algorithms. For example, the function generator module 412 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Naïve Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the function generator module 412 generates learned functions pseudo-randomly, without regard to the effectiveness of the generated learned functions, without prior knowledge regarding the suitability of the generated learned functions for the associated training data, or the like. For example, the function generator module 412 may generate a total number of learned functions that is large enough that at least a subset of the generated learned functions are statistically likely to be effective. As used herein, pseudo-randomly indicates that the function generator module 412 is configured to generate learned functions in an automated manner, without input or selection of learned functions, machine learning classes or models for the learned functions, or the like by a Data Scientist, expert, or other user.

The function generator module 412, in certain embodiments, generates as many learned functions as possible for a requested machine learning ensemble 432, given one or more parameters or limitations. A client 404 may provide a parameter or limitation for learned function generation as part of a new ensemble request or the like to an interface module 402, such as an amount of time; an allocation of system resources such as a number of processor nodes or cores, or an amount of volatile memory; a number of learned functions; runtime constraints on the requested ensemble 432 such as an indicator of whether or not the requested ensemble 432 should provide results in real-time; and/or another parameter or limitation from a client 404.

The number of learned functions that the function generator module 412 may generate for building a machine learning ensemble 432 may also be limited by capabilities of the multi-tenant enabling architecture 100, such as a number of available processors or processor cores, a current load on the multi-tenant enabling architecture 100, a price of remote processing resources over the data network 204; or other hardware capabilities of the multi-tenant enabling architecture 100 available to the function generator module 412. The function generator module 412 may balance the hardware capabilities of the multi-tenant enabling architecture 100 with an amount of time available for generating learned functions and building a machine learning ensemble 432 to determine how many learned functions to generate for the machine learning ensemble 432.

In one embodiment, the function generator module 412 may generate at least 50 learned functions for a machine learning ensemble 432. In a further embodiment, the function generator module 412 may generate hundreds, thousands, or millions of learned functions, or more, for a machine learning ensemble 432. By generating an unusually large number of learned functions from different classes without regard to the suitability or effectiveness of the generated learned functions for training data, in certain embodiments, the function generator module 412 ensures that at least a subset of the generated learned functions, either individually or in combination, are useful, suitable, and/or effective for the training data without careful curation and fine tuning by a Data Scientist or other expert.

Similarly, by generating learned functions from different machine learning classes without regard to the effectiveness or the suitability of the different machine learning classes for training data, the function generator module 412, in certain embodiments, may generate learned functions that are useful, suitable, and/or effective for the training data due to the sheer amount of learned functions generated from the different machine learning classes. This brute force, trial-and-error approach to generating learned functions, in certain embodiments, eliminates or minimizes the role of a Data Scientist or other expert in generation of a machine learning ensemble 432.

The function generator module 412, in certain embodiments, divides initialization data from the data receiver module 408 into various subsets of training data, and may use different training data subsets, different combinations of multiple training data subsets, or the like to generate different learned functions. The function generator module 412 may divide the initialization data into training data subsets by feature, by instance, or both. For example, a training data subset may comprise a subset of features of initialization data, a subset of features of initialization data, a subset of both features and instances of initialization data, or the like. Varying the features and/or instances used to train different learned functions, in certain embodiments, may further increase the likelihood that at least a subset of the generated learned functions are useful, suitable, and/or effective. In a further embodiment, the function generator module 412 ensures that the available initialization data is not used in its entirety as training data for any one learned function, so that at least a portion of the initialization data is available for each learned function as test data.

In one embodiment, the function generator module 412 may also generate additional learned functions in cooperation with the machine learning compiler module 418. The function generator module 412 may provide a learned function request interface, allowing the machine learning compiler module 418 or another module, a client 404, or the like to send a learned function request to the function generator module 412 requesting that the function generator module 412 generate one or more additional learned functions. In one embodiment, a learned function request may include one or more attributes for the requested one or more learned functions. For example, a learned function request, in various embodiments, may include a machine learning class for a requested learned function, one or more features for a requested learned function, instances from initialization data to use as training data for a requested learned function, runtime constraints on a requested learned function, or the like. In another embodiment, a learned function request may identify initialization data, training data, or the like for one or more requested learned functions and the function generator module 412 may generate the one or more learned functions pseudo-randomly, as described above, based on the identified data.

The machine learning compiler module 418, in one embodiment, is configured to form a machine learning ensemble 432 using learned functions from the function generator module 412. As used herein, a machine learning ensemble 432 comprises an organized set of a plurality of learned functions. Providing a classification, a confidence metric, an inferred function, a regression function, an answer, a prediction, a recognized pattern, a rule, a recommendation, an evaluation, a setting, a threshold, a configuration, or another result using a machine learning ensemble 432, in certain embodiments, may be more accurate than using a single learned function.

The machine learning compiler module 418, in certain embodiments, may combine and/or extend learned functions to form new learned functions, may request additional learned functions from the function generator module 412, or the like for inclusion in a machine learning ensemble 432. In one embodiment, the machine learning compiler module 418 evaluates learned functions from the function generator module 412 using test data to generate evaluation metadata. The machine learning compiler module 418, in a further embodiment, may evaluate combined learned functions, extended learned functions, combined-extended learned functions, additional learned functions, or the like using test data to generate evaluation metadata.

The machine learning compiler module 418, in certain embodiments, maintains evaluation metadata in a metadata library 428. The machine learning compiler module 418 may select learned functions (e.g. learned functions from the function generator module 412, combined learned functions, extended learned functions, learned functions from different machine learning classes, and/or combined-extended learned functions) for inclusion in a machine learning ensemble 432 based on the evaluation metadata. In a further embodiment, the machine learning compiler module 418 may synthesize the selected learned functions into a final, synthesized function or function set for a machine learning ensemble 432 based on evaluation metadata. The machine learning compiler module 418, in another embodiment, may include synthesized evaluation metadata in a machine learning ensemble 432 for directing data through the machine learning ensemble 432 or the like.

In one embodiment, the feature selector module 414 determines which features of initialization data to use in the machine learning ensemble 432, and in the associated learned functions, and/or which features of the initialization data to exclude from the machine learning ensemble 432, and from the associated learned functions. As described above, initialization data, and the training data and test data derived from the initialization data, may include one or more features. Learned functions and the machine learning ensembles 432 that they form are configured to receive and process instances of one or more features. Certain features may be more predictive than others, and the more features that the machine learning compiler module 418 processes and includes in the generated machine learning ensemble 432, the more processing overhead used by the machine learning compiler module 418, and the more complex the generated machine learning ensemble 432 becomes. Additionally, certain features may not contribute to the effectiveness or accuracy of the results from a machine learning ensemble 432, but may simply add noise to the results.

The feature selector module 414, in one embodiment, cooperates with the function generator module 412 and the machine learning compiler module 418 to evaluate the effectiveness of various features, based on evaluation metadata from the metadata library 428 described below. For example, the function generator module 412 may generate a plurality of learned functions for various combinations of features, and the machine learning compiler module 418 may evaluate the learned functions and generate evaluation metadata. Based on the evaluation metadata, the feature selector module 414 may select a subset of features that are most accurate or effective, and the machine learning compiler module 418 may use learned functions that utilize the selected features to build the machine learning ensemble 432. The feature selector module 414 may select features for use in the machine learning ensemble 432 based on evaluation metadata for learned functions from the function generator module 412, combined learned functions from the combiner module 420, extended learned functions from the extender module 422, combined extended functions, synthesized learned functions from the synthesizer module 424, or the like.

In a further embodiment, the feature selector module 414 may cooperate with the machine learning compiler module 418 to build a plurality of different machine learning ensembles 432 for the same initialization data or training data, each different machine learning ensemble 432 utilizing different features of the initialization data or training data. The machine learning compiler module 418 may evaluate each different machine learning ensemble 432, using the function evaluator module 426 and the feature selector module 430 may select the machine learning ensemble 432 and the associated features which are most accurate or effective based on the evaluation metadata for the different machine learning ensembles 432. In certain embodiments, the machine learning compiler module 418 may generate tens, hundreds, thousands, millions, or more different machine learning ensembles 432 so that the feature selector module 430 may select an optimal set of features (e.g. the most accurate, most effective, or the like) with little or no input from a Data Scientist, expert, or other user in the selection process.

In one embodiment, the machine learning compiler module 418 may generate a machine learning ensemble 432 for each possible combination of features from which the feature selector module 414 may select. In a further embodiment, the machine learning compiler module 418 may begin generating machine learning ensembles 432 with a minimal number of features, and may iteratively increase the number of features used to generate machine learning ensembles 432 until an increase in effectiveness or usefulness of the results of the generated machine learning ensembles 432 fails to satisfy a feature effectiveness threshold. By increasing the number of features until the increases stop being effective, in certain embodiments, the machine learning compiler module 418 may determine a minimum effective set of features for use in a machine learning ensemble 432, so that generation and use of the machine learning ensemble 432 is both effective and efficient. The feature effectiveness threshold may be predetermined or hard coded, may be selected by a client 404 as part of a new ensemble request or the like, may be based on one or more parameters or limitations, or the like.

During the iterative process, in certain embodiments, once the feature selector module 414 determines that a feature is merely introducing noise, the machine learning compiler module 418 excludes the feature from future iterations, and from the machine learning ensemble 432. In one embodiment, a client 404 may identify one or more features as required for the machine learning ensemble 432, in a new ensemble request or the like. The feature selector module 414 may include the required features in the machine learning ensemble 432, and select one or more of the remaining optional features for inclusion in the machine learning ensemble 432 with the required features.

In a further embodiment, based on evaluation metadata from the metadata library 428, the feature selector module 414 determines which features from initialization data and/or training data are adding noise, are not predictive, are the least effective, or the like, and excludes the features from the machine learning ensemble 432. In other embodiments, the feature selector module 414 may determine which features enhance the quality of results, increase effectiveness, or the like, and selects the features for the machine learning ensemble 432.

In one embodiment, the feature selector module 414 causes the machine learning compiler module 418 to repeat generating, combining, extending, and/or evaluating learned functions while iterating through permutations of feature sets. At each iteration, the function evaluator module 426 may determine an overall effectiveness of the learned functions in aggregate for the current iteration's selected combination of features. Once the feature selector module 414 identifies a feature as noise introducing, the feature selector module may exclude the noisy feature and the machine learning compiler module 418 may generate a machine learning ensemble 432 without the excluded feature. In one embodiment, the predictive correlation module 416 determines one or more features, instances of features, or the like that correlate with higher confidence metrics (e.g. that are most effective in predicting results with high confidence). The predictive correlation module 416 may cooperate with, be integrated with, or otherwise work in concert with the feature selector module 414 to determine one or more features, instances of features, or the like that correlate with higher confidence metrics. For example, as the feature selector module 414 causes the machine learning compiler module 418 to generate and evaluate learned functions with different sets of features, the predictive correlation module 416 may determine which features and/or instances of features correlate with higher confidence metrics, are most effective, or the like based on metadata from the metadata library 428.

The predictive correlation module 416, in certain embodiments, is configured to harvest metadata regarding which features correlate to higher confidence metrics, to determine which feature was predictive of which outcome or result, or the like. In one embodiment, the predictive correlation module 416 determines the relationship of a feature's predictive qualities for a specific outcome or result based on each instance of a particular feature. In other embodiments, the predictive correlation module 416 may determine the relationship of a feature's predictive qualities based on a subset of instances of a particular feature. For example, the predictive correlation module 416 may discover a correlation between one or more features and the confidence metric of a predicted result by attempting different combinations of features and subsets of instances within an individual feature's dataset, and measuring an overall impact on predictive quality, accuracy, confidence, or the like. The predictive correlation module 416 may determine predictive features at various granularities, such as per feature, per subset of features, per instance, or the like.

In one embodiment, the predictive correlation module 416 determines one or more features with a greatest contribution to a predicted result or confidence metric as the machine learning compiler module 418 forms the machine learning ensemble 432, based on evaluation metadata from the metadata library 428, or the like. For example, the machine learning compiler module 418 may build one or more synthesized learned functions 438 that are configured to provide one or more features with a greatest contribution as part of a result. In another embodiment, the predictive correlation module 416 may determine one or more features with a greatest contribution to a predicted result or confidence metric dynamically at runtime as the machine learning ensemble 432 determines the predicted result or confidence metric. In such embodiments, the predictive correlation module 416 may be part of, integrated with, or in communication with the machine learning ensemble 432. The predictive correlation module 416 may cooperate with the machine learning ensemble 432, so that the machine learning ensemble 432 provides a listing of one or more features that provided a greatest contribution to a predicted result or confidence metric as part of a response to an analysis request.

In determining features that are predictive, or that have a greatest contribution to a predicted result or confidence metric, the predictive correlation module 416 may balance a frequency of the contribution of a feature and/or an impact of the contribution of the feature. For example, a certain feature or set of features may contribute to the predicted result or confidence metric frequently, for each instance or the like, but have a low impact. Another feature or set of features may contribute relatively infrequently, but has a very high impact on the predicted result or confidence metric (e.g. provides at or near 100% confidence or the like). While the predictive correlation module 416 is described herein as determining features that are predictive or that have a greatest contribution, in other embodiments, the predictive correlation module 416 may determine one or more specific instances of a feature that are predictive, have a greatest contribution to a predicted result or confidence metric, or the like.

In the depicted embodiment, the machine learning compiler module 418 includes a combiner module 420. The combiner module 420 combines learned functions, forming sets, strings, groups, trees, or clusters of combined learned functions. In certain embodiments, the combiner module 420 combines learned functions into a prescribed order, and different orders of learned functions may have different inputs, produce different results, or the like. The combiner module 420 may combine learned functions in different combinations. For example, the combiner module 420 may combine certain learned functions horizontally or in parallel, joined at the inputs and at the outputs or the like, and may combine certain learned functions vertically or in series, feeding the output of one learned function into the input of another learned function.

The combiner module 420 may determine which learned functions to combine, how to combine learned functions, or the like based on evaluation metadata for the learned functions from the metadata library 428, generated based on an evaluation of the learned functions using test data, as described below with regard to the function evaluator module 426. The combiner module 420 may request additional learned functions from the function generator module 412, for combining with other learned functions. For example, the combiner module 420 may request a new learned function with a particular input and/or output to combine with an existing learned function, or the like.

While the combining of learned functions may be informed by evaluation metadata for the learned functions, in certain embodiments, the combiner module 420 combines a large number of learned functions pseudo-randomly, forming a large number of combined functions. For example, the combiner module 420, in one embodiment, may determine each possible combination of generated learned functions, as many combinations of generated learned functions as possible given one or more limitations or constraints, a selected subset of combinations of generated learned functions, or the like, for evaluation by the function evaluator module 426. In certain embodiments, by generating a large number of combined learned functions, the combiner module 420 is statistically likely to form one or more combined learned functions that are useful and/or effective for the training data.

In the depicted embodiment, the machine learning compiler module 418 includes an extender module 422. The extender module 422, in certain embodiments, is configured to add one or more layers to a learned function. For example, the extender module 422 may extend a learned function or combined learned function by adding a probabilistic model layer, such as a Bayesian belief network layer, a Bayes classifier layer, a Boltzmann layer, or the like.

Certain classes of learned functions, such as probabilistic models, may be configured to receive either instances of one or more features as input, or the output results of other learned functions, such as a classification and a confidence metric, an inferred function, a regression function, an answer, a prediction, a recognized pattern, a rule, a recommendation, an evaluation, or the like. The extender module 422 may use these types of learned functions to extend other learned functions. The extender module 422 may extend learned functions generated by the function generator module 412 directly, may extend combined learned functions from the combiner module 420, may extend other extended learned functions, may extend synthesized learned functions from the synthesizer module 424, or the like.

In one embodiment, the extender module 422 determines which learned functions to extend, how to extend learned functions, or the like based on evaluation metadata from the metadata library 428. The extender module 422, in certain embodiments, may request one or more additional learned functions from the function generator module 412 and/or one or more additional combined learned functions from the combiner module 420, for the extender module 422 to extend.

While the extending of learned functions may be informed by evaluation metadata for the learned functions, in certain embodiments, the extender module 422 generates a large number of extended learned functions pseudo-randomly. For example, the extender module 422, in one embodiment, may extend each possible learned function and/or combination of learned functions, may extend a selected subset of learned functions, may extend as many learned functions as possible given one or more limitations or constraints, or the like, for evaluation by the function evaluator module 426. In certain embodiments, by generating a large number of extended learned functions, the extender module 422 is statistically likely to form one or more extended learned functions and/or combined extended learned functions that are useful and/or effective for the training data.

In the depicted embodiment, the machine learning compiler module 418 includes a synthesizer module 424. The synthesizer module 424, in certain embodiments, is configured to organize a subset of learned functions into the machine learning ensemble 432, as synthesized learned functions 438. In a further embodiment, the synthesizer module 424 includes evaluation metadata from the metadata library 428 of the function evaluator module 426 in the machine learning ensemble 432 as a synthesized metadata rule set 436, so that the machine learning ensemble 432 includes synthesized learned functions 438 and evaluation metadata, the synthesized metadata rule set 436, for the synthesized learned functions 438.

The learned functions that the synthesizer module 424 synthesizes or organizes into the synthesized learned functions 438 of the machine learning ensemble 432, may include learned functions directly from the function generator module 412, combined learned functions from the combiner module 420, extended learned functions from the extender module 422, combined extended learned functions, or the like. In one embodiment, the function selector module 430 selects the learned functions for the synthesizer module 424 to include in the machine learning ensemble 432. In certain embodiments, the synthesizer module 424 organizes learned functions by preparing the learned functions and the associated evaluation metadata for processing workload data to reach a result. For example, the synthesizer module 424 may organize and/or synthesize the synthesized learned functions 438 and the synthesized metadata rule set 436 for the orchestration module 434 to use to direct workload data through the synthesized learned functions 438 to produce a result.

In one embodiment, the function evaluator module 426 evaluates the synthesized learned functions 438 that the synthesizer module 424 organizes, and the synthesizer module 424 synthesizes and/or organizes the synthesized metadata rule set 436 based on evaluation metadata that the function evaluation module 426 generates during the evaluation of the synthesized learned functions 438, from the metadata library 428 or the like.

In the depicted embodiment, the machine learning compiler module 418 includes a function evaluator module 426. The function evaluator module 426 is configured to evaluate learned functions using test data, or the like. The function evaluator module 426 may evaluate learned functions generated by the function generator module 412, learned functions combined by the combiner module 420 described above, learned functions extended by the extender module 422 described above, combined extended learned functions, synthesized learned functions 438 organized into the machine learning ensemble 432 by the synthesizer module 424 described above, or the like.

Test data for a learned function, in certain embodiments, comprises a different subset of the initialization data for the learned function than the function generator module 412 used as training data. The function evaluator module 426, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, a setting, a threshold, a configuration, or another result.

Test data, in certain embodiments, comprises a subset of initialization data, with a feature associated with the requested result removed, so that the function evaluator module 426 may compare the result from the learned function to the instances of the removed feature to determine the accuracy and/or effectiveness of the learned function for each test instance. For example, if a client 404 has requested a machine learning ensemble 432 to predict whether a customer will be a repeat customer, and provided historical customer information as initialization data, the function evaluator module 426 may input a test data set comprising one or more features of the initialization data other than whether the customer was a repeat customer into the learned function, and compare the resulting predictions to the initialization data to determine the accuracy and/or effectiveness of the learned function.

The function evaluator module 426, in one embodiment, is configured to maintain evaluation metadata for an evaluated learned function in the metadata library 428. The evaluation metadata, in certain embodiments, comprises log data generated by the function generator module 412 while generating learned functions, the function evaluator module 312 while evaluating learned functions, or the like.

In one embodiment, the evaluation metadata includes indicators of one or more training data sets that the function generator module 412 used to generate a learned function. The evaluation metadata, in another embodiment, includes indicators of one or more test data sets that the function evaluator module 426 used to evaluate a learned function. In a further embodiment, the evaluation metadata includes indicators of one or more decisions made by and/or branches taken by a learned function during an evaluation by the function evaluator module 426. The evaluation metadata, in another embodiment, includes the results determined by a learned function during an evaluation by the function evaluator module 426. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data, and may be represented by a correctness indicator for each evaluated instance, a percentage, a ratio, or the like. Different classes of learned functions, in certain embodiments, may have different types of evaluation metadata.

The metadata library 428, in one embodiment, provides evaluation metadata for learned functions to the feature selector module 430, the predictive correlation module 416, the combiner module 420, the extender module 422, and/or the synthesizer module 424. The metadata library 428 may provide an API, a shared library, one or more function calls, or the like providing access to evaluation metadata. The metadata library 428, in various embodiments, may store or maintain evaluation metadata in a database format, as one or more flat files, as one or more lookup tables, as a sequential log or log file, or as one or more other data structures. In one embodiment, the metadata library 428 may index evaluation metadata by learned function, by feature, by instance, by training data, by test data, by effectiveness, and/or by another category or attribute and may provide query access to the indexed evaluation metadata. The function evaluator module 426 may update the metadata library 428 in response to each evaluation of a learned function, adding evaluation metadata to the metadata library 428 or the like.

The function selector module 430, in certain embodiments, may use evaluation metadata from the metadata library 428 to select learned functions for the combiner module 420 to combine, for the extender module 422 to extend, for the synthesizer module 424 to include in the machine learning ensemble 432, or the like. For example, in one embodiment, the function selector module 414 may select learned functions based on evaluation metrics, learning metrics, effectiveness metrics, convergence metrics, or the like. In another embodiment, the function selector module 430 may select learned functions for the combiner module 420 to combine and/or for the extender module 422 to extend based on features of training data used to generate the learned functions, or the like.

The machine learning ensemble 432, in certain embodiments, provides machine learning results for an analysis request by processing workload data of the analysis request using a plurality of learned functions (e.g., the synthesized learned functions 438). As described above, results from the machine learning ensemble 432, in various embodiments, may include a classification, a confidence metric, an inferred function, a regression function, an answer, a prediction, a recognized pattern, a rule, a recommendation, an evaluation, and/or another result. For example, in one embodiment, the machine learning ensemble 432 provides a classification and a confidence metric for each instance of workload data input into the machine learning ensemble 432, or the like. Workload data, in certain embodiments, may be substantially similar to test data, but the missing feature from the initialization data is not known, and is to be solved for by the machine learning ensemble 432. A classification, in certain embodiments, comprises a value for a missing feature in an instance of workload data, such as a prediction, an answer, or the like. For example, if the missing feature represents a question, the classification may represent a predicted answer, and the associated confidence metric may be an estimated strength or accuracy of the predicted answer. A classification, in certain embodiments, may comprise a binary value (e.g., yes or no), a rating on a scale (e.g., 4 on a scale of 1 to 5), or another data type for a feature. A confidence metric, in certain embodiments, may comprise a percentage, a ratio, a rating on a scale, or another indicator of accuracy, effectiveness, and/or confidence.

In the depicted embodiment, the machine learning ensemble 432 includes an orchestration module 434. The orchestration module 434, in certain embodiments, is configured to direct workload data through the machine learning ensemble 432 to produce a result, such as a classification, a confidence metric, an inferred function, a regression function, an answer, a prediction, a recognized pattern, a rule, a recommendation, an evaluation, a setting, a threshold, a configuration, and/or another result. In one embodiment, the orchestration module 434 uses evaluation metadata from the function evaluator module 426 and/or the metadata library 428, such as the synthesized metadata rule set 436, to determine how to direct workload data through the synthesized learned functions 438 of the machine learning ensemble 432. In certain embodiments, the synthesized metadata rule set 436 comprises a set of rules or conditions from the evaluation metadata of the metadata library 428 that indicate to the orchestration module 434 which features, instances, or the like should be directed to which synthesized learned function 438.

For example, the evaluation metadata from the metadata library 428 may indicate which learned functions were trained using which features and/or instances, how effective different learned functions were at making predictions based on different features and/or instances, or the like. The synthesizer module 424 may use that evaluation metadata to determine rules for the synthesized metadata rule set 436, indicating which features, which instances, or the like the orchestration module 434 the orchestration module 434 should direct through which learned functions, in which order, or the like. The synthesized metadata rule set 436, in one embodiment, may comprise a decision tree or other data structure comprising rules which the orchestration module 434 may follow to direct workload data through the synthesized learned functions 438 of the machine learning ensemble 432.

The interface module 402, in certain embodiments, is configured to receive requests from clients 404, to provide results to a client 404, or the like. The machine learning module 410, for example, may act as a client 404, requesting a machine learning ensemble 432 from the interface module 402 or the like. The interface module 402 may provide a machine learning interface to clients 404, such as an API, a shared library, a hardware command interface, or the like, over which clients 404 may make requests and receive results. The interface module 402 may support new ensemble requests from clients 404, allowing clients 404 to request generation of a new machine learning ensemble 432 from the machine learning module 410 or the like. As described above, a new ensemble request may include initialization data; one or more ensemble parameters; a feature, query, question or the like for which a client 404 would like a machine learning ensemble 432 to predict a result; or the like. The interface module 402 may support analysis requests for a result from a machine learning ensemble 432. As described above, an analysis request may include workload data; a feature, query, question or the like; a machine learning ensemble 432; or may include other analysis parameters.

In certain embodiments, the machine learning module 410 may maintain a library of generated machine learning ensembles 432, from which clients 404 may request results. In such embodiments, the interface module 402 may return a reference, pointer, or other identifier of the requested machine learning ensemble 432 to the requesting client 404, which the client 404 may use in analysis requests. In another embodiment, in response to the machine learning module 410 generating a machine learning ensemble 432 to satisfy a new ensemble request, the interface module 402 may return the actual machine learning ensemble 432 to the client 404, for the client 404 to manage, and the client 404 may include the machine learning ensemble 432 in each analysis request.

The interface module 402 may cooperate with the machine learning module 410 to service new ensemble requests, may cooperate with the machine learning ensemble 432 to provide a result to an analysis request, or the like. The machine learning module 410, in the depicted embodiment, includes the function generator module 412, the feature selector module 414, the predictive correlation module 416, and the machine learning compiler module 418, as described above. The machine learning module 410, in the depicted embodiment, also includes a data repository 406.

The data repository 406, in one embodiment, stores initialization data, so that the function generator module 412, the feature selector module 414, the predictive correlation module 416, and/or the machine learning compiler module 418 may access the initialization data to generate, combine, extend, evaluate, and/or synthesize learned functions and machine learning ensembles 432. The data repository 406 may provide initialization data indexed by feature, by instance, by training data subset, by test data subset, by new ensemble request, or the like. By maintaining initialization data in a data repository 406, in certain embodiments, the machine learning module 410 ensures that the initialization data is accessible throughout the machine learning ensemble 432 building process, for the function generator module 412 to generate learned functions, for the feature selector module 414 to determine which features should be used in the machine learning ensemble 432, for the predictive correlation module 416 to determine which features correlate with the highest confidence metrics, for the combiner module 420 to combine learned functions, for the extender module 422 to extend learned functions, for the function evaluator module 426 to evaluate learned functions, for the synthesizer module 424 to synthesize learned functions 438 and/or metadata rule sets 436, or the like.

In the depicted embodiment, the data receiver module 408 is integrated with the interface module 402, to receive initialization data, including training data and test data, from new ensemble requests. The data receiver module 408 stores initialization data in the data repository 406. The function generator module 412 is in communication with the data repository 406, in one embodiment, so that the function generator module 412 may generate learned functions based on training data sets from the data repository 406. The feature selector module 414 and/or the predictive correlation module 416, in certain embodiments, may cooperate with the function generator module 412 and/or the machine learning compiler module 418 to determine which features to use in the machine learning ensemble 432, which features are most predictive or correlate with the highest confidence metrics, or the like.

Within the machine learning compiler module 418, the combiner module 420, the extender module 422, and the synthesizer module 424 are each in communication with both the function generator module 412 and the function evaluator module 426. The function generator module 412, as described above, may generate an initial large amount of learned functions, from different classes or the like, which the function evaluator module 426 evaluates using test data sets from the data repository 406. The combiner module 420 may combine different learned functions from the function generator module 412 to form combined learned functions, which the function evaluator module 426 evaluates using test data from the data repository 406. The combiner module 420 may also request additional learned functions from the function generator module 412.

The extender module 422, in one embodiment, extends learned functions from the function generator module 412 and/or the combiner module 420. The extender module 422 may also request additional learned functions from the function generator module 412. The function evaluator module 426 evaluates the extended learned functions using test data sets from the data repository 406. The synthesizer module 424 organizes, combines, or otherwise synthesizes learned functions from the function generator module 412, the combiner module 420, and/or the extender module 422 into synthesized learned functions 438 for the machine learning ensemble 432. The function evaluator module 426 evaluates the synthesized learned functions 438, and the synthesizer module 424 organizes or synthesizes the evaluation metadata from the metadata library 428 into a synthesized metadata rule set 436 for the synthesized learned functions 438.

As described above, as the function evaluator module 426 evaluates learned functions from the function generator module 412, the combiner module 420, the extender module 422, and/or the synthesizer module 424, the function evaluator module 426 generates evaluation metadata for the learned functions and stores the evaluation metadata in the metadata library 428. In the depicted embodiment, in response to an evaluation by the function evaluator module 426, the function selector module 414 selects one or more learned functions based on evaluation metadata from the metadata library 428. For example, the function selector module 430 may select learned functions for the combiner module 420 to combine, for the extender module 422 to extend, for the synthesizer module 424 to synthesize, or the like.

FIG. 5 depicts one embodiment of an apparatus 500 that includes a multitenancy apparatus 206. In certain embodiments, the multitenancy apparatus 206 includes a layer communication gateway module 502, a common repository module 504, and a user interface gateway module 506, which are described in greater detail below.

In one embodiment, the multitenancy apparatus 206 includes a layer communication gateway module 502 configured to tag data associated with multiple tenants. In some embodiments, the data is processed, created, stored, or the like by a single-tenant computer program product 112. In certain embodiments, a tag is uniquely associated with a tenant so that data associated with a tenant may be easily tracked to the tenant, even though there may be multiple tenants executing the single-tenant computer program product 112. In this manner, the single-tenant computer program product 112 may service multiple tenants because the single-tenant computer program product 112 may process data associated with multiple tenants while the layer communication gateway module 502 ensures the data associated with one tenant is isolated from data associated with a different tenant. Thus, the single-tenant computer program product 112 may not discriminate between data associated with different tenants, but instead may process data as it is received.

In one embodiment, the layer communication gateway module 502 creates one or more unique tags associated with a single tenant. In another embodiment, the layer communication gateway module 502 creates one or more unique tags based on credentials, such as a user name, entered by a user at the user portal 202 to access the single-tenant computer program product 112. In a further embodiment, the layer communication gateway module 502 creates one or more tags comprising a string of random characters.

In some embodiments, the layer communication gateway module 502 facilitates and controls the flow of data between different layers of the multi-tenant enabling architecture 100. For example, the layer communication gateway module 502 may retrieve data from one or more monitoring servers 308 and send the data to a pattern recognition engine 208, a data repository 210, one or more user interface servers 304, the user portal 202, or the like. In some embodiments, the layer communication gateway module 502 queries a data store associated with one or more assigned monitoring servers 308 to locate the assigned monitoring server 308 comprising processed data, machine learning results, or the like having a tag associated with the single tenant. In another embodiment, the layer communication gateway module 502 retrieves data from one or more monitoring servers 308 by checking a data repository 210 to determine which monitoring servers 308 are assigned to a user/tenant (e.g., by looking up the assignment in a database by the tag associated with the user), and, therefore, are storing data associated with the user.

In a further embodiment, the layer communication gateway module 502 retrieves data from one or more monitoring servers 308 and forwards the data to the pattern recognition engine 208, where it can be analyzed and processed, as described above. In certain embodiments, the layer communication gateway module 502 retrieves data from the one or more monitoring servers 308 and sends it to the pattern recognition engine 208 on a regular basis. For example, the layer communication gateway module 502 may retrieve data associated with a single tenant from the monitoring servers 308 and forward the data to the pattern recognition engine 208 every five minutes, fifteen minutes, or the like.

In one embodiment where the single-tenant computer program product 112 is an enterprise management software application, the layer communication gateway module 502 retrieves raw event data associated with the single tenant (by using the tag associated with the tenant) and forwards the raw event data to the pattern recognition engine 208. As described in greater detail below with reference to the pattern recognition module 610, the pattern recognition engine 208, in certain embodiments, processes the raw event data to determine a classification, a confidence metric, an inferred function, a regression function, an answer, a prediction, a recognized pattern, a rule, a recommendation, an evaluation, a setting, a threshold, a configuration, or the like for a user or tenant, for the single-tenant computer program product 112, for the user interface gateway module 506, or the like.

In one embodiment, the layer communication gateway module 502 receives data requests from one or more user interface servers 304 in the user interface layer 302 and directs the user interface servers 304 to one or more monitoring servers 308 storing a user's data. In another embodiment, the layer communication gateway module 502, as described above, queries the data repository 210 to determine which monitoring servers 308 are storing data associated with the user. The layer communication gateway module 502 may query the data repository 210 using a unique tag associated with the user and the user's data so that other tenant's data is not exposed to the user.

In one embodiment, the multitenancy apparatus 206 includes a common repository module 504 configured to provide the data to the single-tenant computer program product 112. In certain embodiments, the common repository module 504 retrieves data associated with multiple tenants from a data repository 210. In some embodiments, the common repository module 504 retrieves the data based on a tag associated with a single tenant and the tenant's data. Thus, as a tenant is interacting with the single-tenant computer program product 112 through the user portal 202, the common repository module 504 may retrieve only the user's data based on a unique tag associated with the user, even though multiple user's data may be stored alongside the user's data.

In certain embodiments, the common repository module 504 is in communication with one or more gateways 106, 108, 110, modules, such as a layer communication gateway module 502, a user interface gateway module 506, an agent gateway module 602, a pattern recognition module 610, servers 304, 308, or the like. In some embodiments, the common repository module 504 stores user data in a data store, such as a database, and allows different components, such as the gateways 106, 108, 100, to query the data store to retrieve data associated with one or more users based on a tag or similar identifier.

In another embodiment, the multitenancy apparatus 206 includes a user interface gateway module 506 configured to present a user interface for the computer program product 112 to a single tenant based on one or more tags associated with the single tenant. In one embodiment, the user interface gateway module 506 is in communication with the user portal 202 in order to present to the user various user interface components associated with the single-tenant computer program product 112 and the user's data. For example, the user portal 202 may request one or more reports, dashboards, gauges, charts, or the like for a single tenant. In certain embodiments, the user interface gateway module 506 is in communication with the user portal 202 through the data network 204. For example, the user portal 202 may be embodied as a website that the user views by executing a web browser that is in communication with the user interface gateway module 506.

In one embodiment, the user interface gateway module 506 is also in communication with the common repository module 504 to retrieve information regarding the location of a tenant's user interface data on the one or more user interface servers 304. In another embodiment, the user interface gateway module 506 stores user interface data, such as dashboards, reports, and the like, associated with multiple users in one or more user interface servers 304 located in the user interface layer 302. In one embodiment, the user interface gateway module 506 queries a data store associated with one or more user interface servers 304 to locate a user interface server 304 comprising data having a tag associated with the single tenant.

In another embodiment, the user interface gateway module 506 requests the location (e.g., the user interface server 304) of the user interface data from the common repository module 504, which may then query a data repository 210 to retrieve the requested information. In certain embodiments, the user interface gateway module 506 provides one or more tags associated with the user in order to retrieve user interface data associated with the user. Thus, even though multiple user's data may be stored alongside each other on the user interface servers 304, the user interface gateway module 506 ensures that only the single tenant's user interface data is accessed, by providing one or more unique tags associated with the single tenant, without exposing other tenant's data.

In certain embodiments, the user interface gateway module 506 allows a user to customize and configure the single-tenant computer program product 112. In one embodiment, a user's customization and configuration settings are stored in a data repository 210, which may be accessed by the single-tenant computer program product 112. In another embodiment, the user interface gateway module 506 is in communication with the layer communication gateway module 502 in order to send and/or retrieve information to/from the pattern recognition engine 208. For example, the user interface gateway module 506 may request pattern recognition data or machine learning results, such as a classification, a confidence metric, an inferred function, a regression function, an answer, a prediction, a recognized pattern, a rule, a recommendation, an evaluation, a setting, a threshold, a configuration, or the like, from the layer communication gateway module 502, which may query a data store associated with the pattern recognition engine 208 to find the user's data. In certain embodiments, the user interface gateway module 506 provides one or more tags associated with a user to the layer communication gateway module 502, which then provides the one or more tags to the pattern recognition engine 208 in order to retrieve only pattern recognition data associated with the single tenant without accessing other tenant's data.

FIG. 6 depicts one embodiment of another apparatus 600 that includes a multitenancy apparatus 206. In one embodiment, the multitenancy apparatus 206 includes a layer communication gateway module 502, a common repository module 504, and a user interface gateway module 506, which are substantially similar to the layer communication gateway module 502, common repository module 504, and user interface gateway module 506 described with reference to FIG. 5. In a further embodiment, the multitenancy apparatus 206 includes an agent gateway module 602 that further includes a translation module 604, a server selection module 606, and an assignment logging module 608. In another embodiment, the user interface gateway module 506 includes a data organization module 610. In one embodiment, the multitenancy apparatus 206 also includes a pattern recognition module 610. These modules are described in greater detail below.

The multitenancy apparatus 206, in certain embodiments, includes an agent gateway module 602. In one embodiment, the agent gateway module 602 is configured to forward data from one or more monitoring agents 212 to one or more monitoring servers 308 executing the single-tenant computer program product 112. In another embodiment, the single-tenant computer program product 112 processes the data and/or stores the data in a data store located on monitoring server 308 associated with the single-tenant computer program product 112. In certain embodiments, as described above, a monitoring agent 212 may include an application that sends messages, data, or the like, to the multitenancy apparatus 206, which may be received by the agent gateway module 602. For example, the monitoring agents 212 may include one or more different enterprise management software instances, such as Foglight®, OpenView®, Oracle Enterprise Manager, System Center Configuration Manager, Tivoli Management Framework, ZENWorks®, Patrol®, or the like. In one embodiment, the one or more monitoring agents 212 are associated with multiple tenants executing the single-tenant computer program product 112. Thus, multiple tenants associated with multiple monitoring agents 212 may utilize a computer program product 112 natively configured for single-tenant use without the single-tenant computer program product 112 being aware that the data is associated with multiple tenants instead of a single user.

In another embodiment, the data sent by the monitoring agents 212 to the agent gateway module 602 includes monitoring agent event messages generated by the monitoring agents 212. In some embodiments, the monitoring agent event messages are associated with one or more enterprise management software programs. In certain embodiments, the agent gateway module 602 includes a translation module 604 configured to translate one or more monitor agent event messages so that the one or more monitor agent event messages are readable by the single-tenant computer program product 112. For example, the translation module 604 may receive an event message from a monitoring agent 212 running an instance of IBM's® Tivoli and translate the message into a nomenclature readable by an instance of Foglight® running on a monitoring server 308, or vice versa. In certain embodiments, the translation module 604 maps event message data from a format associated with the application running on the agent 212 to a different format associated with the single-tenant computer program product 112.

In this manner, the multitenancy apparatus 206 is able to provide a single sign-on system for a user associated with multiple monitoring agents 212 running different software applications. The multitenancy apparatus 206, in certain embodiments, consolidates and processes event message data from multiple monitoring agents 212 and presents an interface to the user that contains information from the multiple monitoring agents 212 associated with the user. Thus, the user is able provide a single login to access all their data associated with the monitoring agents 212 and processed by the single-tenant computer program product 112 instead of providing login information separately for each monitoring agent 212.

In one embodiment, the agent gateway module 602 includes a server selection module 606 configured to select a monitoring server 308 to process one or more monitor agent event messages based on one or more processing criteria. In certain embodiments, server selection module 606 selects a monitoring server 308 based on a previous assignment of a monitoring agent 212 to a monitoring server 308. In one embodiment, as described below, an assignment logging module 608 logs an assignment of a monitoring agent 212 to a monitoring server 308 so that the server selection module 606 may look-up the monitoring server 308 assigned to the monitoring agent 212.

In certain embodiments, the server selection module 606 selects a monitoring server 308 based on one or more processing criteria, regardless of any previous assignment. In certain embodiments, the processing criteria includes processing times (e.g., which server 308 is the least/most busy), the type of event (e.g., database, Java, .NET, OS, or the like), a tenant-specific server 308 associated with the monitoring agent 212, or the like. For example, data from monitoring agent 212 A may be assigned to be sent to monitoring server 308 A. However, if monitoring server 308 A is busy processing a large number of event messages, the server selection module 606 may dynamically select monitoring server 308 B to process data from monitoring agent 212 A.

In certain embodiments, the agent gateway module 602 assigns a monitoring agent 212 to a monitoring server 308 executing an instance of the single-tenant computer program product 112 based on the server selection module's 606 selection. In one embodiment, after the agent gateway module 602 assigns a monitoring agent 212 to a monitoring server 308, the agent gateway module 602 forwards data received by the monitoring agent 212 to the assigned monitoring server 308.

In one embodiment, the agent gateway module 602 includes an assignment logging module 608 configured to log an assignment of a monitoring agent 212 to a monitoring server 308, so that data having a tag associated with the single tenant is tracked to the assigned monitoring server 308. In some embodiments, the assignment logging module 608 logs the assignment of a monitoring agent 212 to a monitoring server 308 in a data repository 210. In certain embodiments, the assignment logging module 608 sends the assignment information to a common repository module 504, which may store the information in a data repository 210. In this manner, other components of the multitenancy apparatus 206 may find and access a user's data located in one or more monitoring servers 308 based on a tag associated with the user and the user's data.

In one embodiment, the assignment logging module 608 updates the assignment information in response to the agent gateway module 602 selecting a new monitoring server 308 to process the received data. In some embodiments, as described above, a server selection module 606 selects which monitoring servers 308 may process the data received by the agent gateway module 602 based on one or more processing criteria and sends the assignment information to the assignment logging module 608 to be stored in the data repository 210.

In another embodiment, the multitenancy apparatus 206 includes a pattern recognition module 610 configured to provide data processed by the single-tenant computer program product 112 (e.g., input data for the single-tenant computer program product 112, output data from the single-tenant computer program product 112, or the like) to a pattern recognition engine 208. In certain embodiments, the layer communication gateway 502 uses the pattern recognition module 610 to send and/or retrieve data to/from the pattern recognition engine 208. In one embodiment, the pattern recognition engine 208 processes monitoring agent event messages sent by one or more monitoring agents 212 associated with a tenant to machine learning results such as a classification, a confidence metric, an inferred function, a regression function, an answer, a prediction, a recognized pattern, a rule, a recommendation, an evaluation, a setting, a threshold, a configuration, or the like associated with an enterprise management system. The pattern recognition module 610, in certain embodiments, tags processed data, machine learning results, or the like with the same tag as the event message data stored in the monitoring servers 308, so that the data is associated with a tenant. In a further embodiment, the pattern recognition module 610 sends processed data, machine learning results, or the like to one or more user interface servers 304 so that the data may be incorporated into one or more user interface components.

In another embodiment, the user interface gateway module 506 of the multitenancy apparatus 206 includes a data organization module 612 configured to organize the data into one or more user interface components. In another embodiment, the data organization module 612 stores data associated with the one or more user interface components in a user interface server 304. In one embodiment, the data organization module 612 retrieves data from one or more user interface servers 304 based on one or more tags associated with a user and the user's data. For example, the data organization module 612 may retrieve user interface data associated with a user by using a tag associated with the user to look-up data located in one or more user interface servers 304. As described above, by using a tag associated with the user and the user's data and user interface components, the data organization module 612 is able to only access the user's data without accessing other tenant's data that may be stored on one or more of the user interface servers 304. The data organization module 612, in some embodiments, organizes the data into different user interface components, such as dashboards, gauges, reports, charts, graphs, or the like.

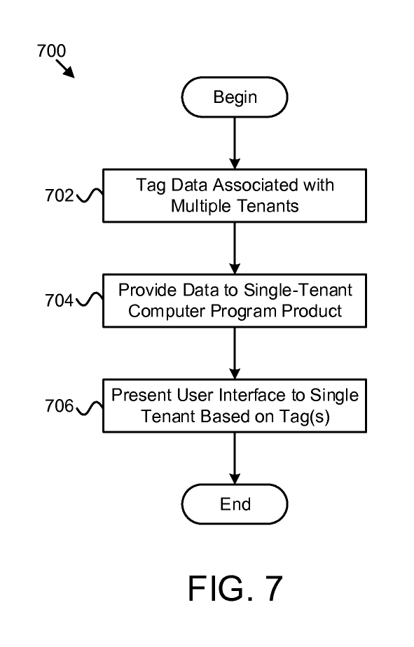

FIG. 7 depicts one embodiment of method 700 for multi-tenant enabling a single-tenant computer program product 112. In one embodiment, the method 700 begins and the layer communication gateway module 502 tags 702 data associated with multiple tenants, where a tag may be uniquely associated with a tenant. In another embodiment, a common repository module 504 provides 704 the data to a single-tenant computer program product 112. In some embodiments, the data is associated with multiple tenants. In a further embodiment, a user interface gateway 506 presents 706 a user interface for the computer program product to a single tenant based on one or more tags associated with the single tenant and the method 700 ends.

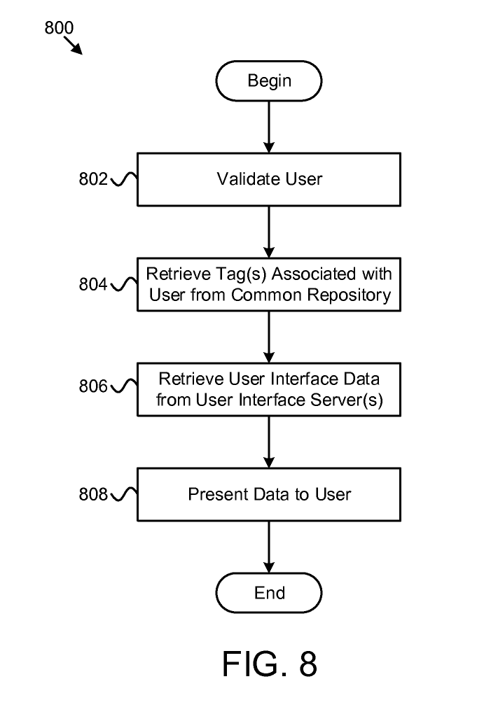

FIG. 8 depicts one embodiment of a method 800 for presenting data to a user. In one embodiment, the method 800 begins and the user interface gateway module 506 validates 802 a user. In one embodiment, a user provides credentials, such as a username and/or password, at a user portal 202. The user portal 202, in another embodiment, forwards the credentials to a user interface gateway module 506, which validates 802 the user. In certain embodiments, the user interface gateway module 506 ensures the user's credentials are valid by checking them against stored credentials (e.g., credentials stored in the data repository 210) associated with the user.

Upon successful login, in a further embodiment, the user interface gateway module 506 retrieves 804 one or more tags associated with the user from a data repository 210. In one embodiment, the user interface gateway module 506 uses a common repository module 504 to query the data repository 210 to retrieve one or more tags associated with the user. In another embodiment, the user interface gateway module 506 queries the data repository 210 to retrieve the location of the user's data, e.g., one or more user interface servers 304 storing user interface data associated with a user.

In one embodiment, the user interface gateway module 506 retrieves 806 user interface data from the one or more user interface servers storing user interface data associated with the user. In certain embodiments, the user interface gateway module 506 provides one or more tags associated with the user and the user's data in order to retrieve only the user's data without retrieving data associated with other tenants and not the user. The user interface data, in certain embodiments, may include one or more dashboards, gauges, charts, graphs, reports, or the like. In another embodiment, the user interface data includes machine learning results as outputted by the pattern recognition engine 206, such as a classification, a confidence metric, an inferred function, a regression function, an answer, a prediction, a recognized pattern, a rule, a recommendation, an evaluation, a setting, a threshold, a configuration, or the like.

In one embodiment, the user interface module 506 presents 808 one or more user interface components to a user. In some embodiments, the user interface module 506 presents 808 the user interface components in a user portal 202. In another embodiment, the user interface module 506 presents 808 data associated with alerts rules, thresholds, or the like. In some embodiments, the user may customize settings, such as alert rules and thresholds, associated with the single-tenant computer program product 112, which the user interface module 506 receives and stores in the data repository 210. In one embodiment, the layer communication gateway module 502 retrieves the customized settings (e.g., the alert rules and thresholds) and stores them in a monitor layer server 308 associated with the user. The method 800 ends.

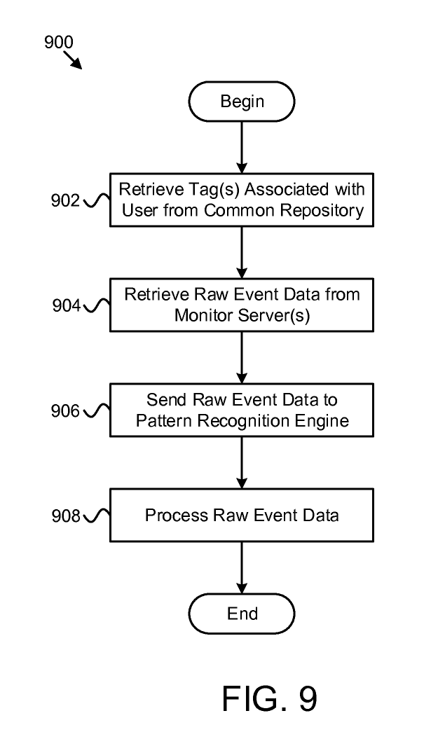

FIG. 9 depicts one embodiment of a method 900 for processing data using a pattern recognition engine 206. In one embodiment, the method 900 begins and a layer communication gateway module 502 retrieves 902 one or more tags associated with a user. In one embodiment, the layer communication gateway module 502 queries a data repository 210 to retrieve one or more tags associated with the user. In another embodiment, the layer communication gateway module 502 queries the data repository 210 to determine which monitoring servers 308 store the data associated with the user.

In one embodiment, the layer communication gateway module 502 retrieves 904 data from one or more monitoring servers 308. In some embodiments, the data includes raw event data associated with the user and stored in the monitoring servers 308 so that the raw event data may be retrieved using a tag associated with the user. In some embodiments, the layer communication gateway module 502 sends 906 the raw event data to a pattern recognition engine 208, which may store the data in an internal data store. In another embodiment, the pattern recognition module 610 provides the data to the pattern recognition engine 206.

In certain embodiments, the pattern recognition engine 208 processes 908 the raw event data using machine learning and produces results based on recognized patterns in the data, such as a classification, a confidence metric, an inferred function, a regression function, an answer, a prediction, a recognized pattern, a rule, a recommendation, an evaluation, a setting, a threshold, a configuration, or the like. In some embodiments, the pattern recognition engine 208 creates thresholds, settings, and/or alert rules for the single-tenant computer program product 112 based on patterns recognized in the event data. In some embodiments, the pattern recognition module 610 stores the thresholds, settings, and/or alert rules in a data store associated with the pattern recognition engine 208. In a further embodiment, the layer communication gateway module 502 stores the thresholds, settings, and/or alert rules created by the pattern recognition engine 208 in one or more monitoring servers 308 associated with a tenant or user. The method 900 ends.

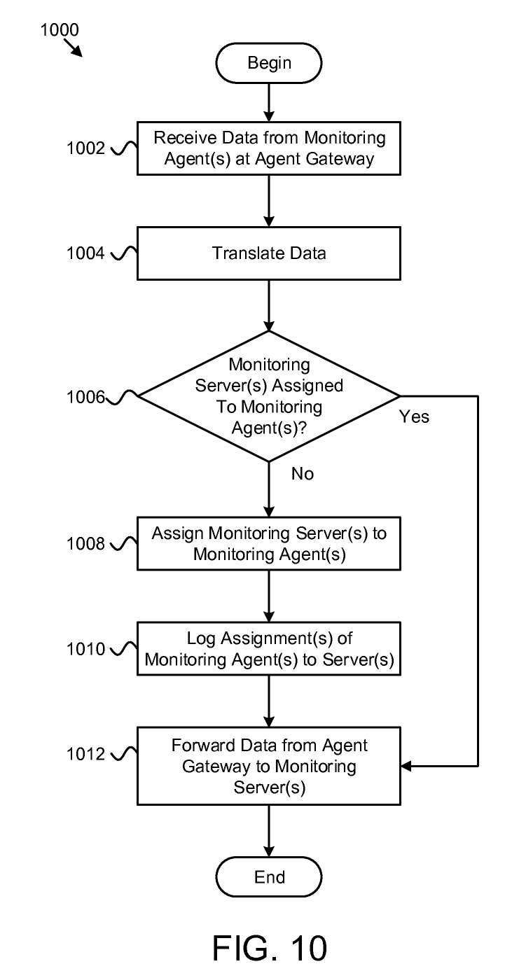

FIG. 10 depicts one embodiment of a method 1000 for receiving data from a monitoring agent 212. In one embodiment, the method 1000 begins and the agent gateway 106 receives 1002 data from one or more monitoring agents 212. In certain embodiments, an agent gateway module 602 receives 1002 the data and translates 1004 the data to a nomenclature that is readable by the single-tenant computer program product 112. For example, the agent gateway module 602 may receive event message data from a monitoring agent 212 running an instance of IBM's® Tivoli software and a translation module 604 may translate the event message data from a Tivoli format to a Foglight® format running on a monitoring server 308, or the like.

In one embodiment, an agent gateway module 602 determines 1006 whether a monitoring agent 212 has already been assigned to a monitoring server 308. If the agent gateway module 602 determines that the monitoring agent 212 has not been assigned to a monitoring server 308, the agent gateway module 602 assigns 1008 the monitoring agent 212 to a monitoring server 308. In one embodiment, a server selection module 606 determines an appropriate monitoring server 308 based on one or more processing criteria, such as the current workload of a monitoring server 308, the type of event message, or the like. In certain embodiments, once a monitoring server 308 is assigned to a monitoring agent 212, an assignment logging module 608 logs 1010 the assignment in a data repository 210 so that other components, such as the user interface gateway module 506, the layer communication gateway module 502, the pattern recognition module 610, or the like, may query the data repository 210 to find which monitoring servers 308 store the user's data.

After an assignment 1008 is made, in one embodiment, or after an assignment is determined 1006 to have been previously established, the agent gateway module 602 forwards 1012 the data to one or more assigned monitoring servers 308. The one or more monitoring servers 308 may store data from multiple tenants. However, a single tenant's data may be retrieved by providing one or more tags associated with the user and the data. The method 1000 ends.

FIG. 11 depicts one embodiment of a method 1100 for capturing data packets. In one embodiment, the method 1100 begins and a packet capturing module 212a, such as a monitoring agent 212 described above, captures 1102, on a first computing device, data packets intended for the first computing device. In certain embodiments, the packet capturing module 212a executes on the first computing device. In another embodiment, the data packets include an identifier for a final destination. For example, the data packets may include a header comprising an IP address of a computing device connected to a data network. In certain embodiments, the packet capturing module 212a captures data packets by intercepting data packets intended for the first computing device without accessing network equipment external to the first computing device. In another embodiment, the first computing device includes one or more virtual machines executing on the first computing device and the packet capturing module 212a captures one or more data packets from within each virtual machine.

In one embodiment, the packet capturing module 212a discards 1104 one or more captured data packets in response to the discarded one or more of the data packets failing to satisfy one or more filtering criterion. In certain embodiments, the one or more filtering criterion include a network protocol, a data type, a data packet source, a data packet destination, or the like.

In one embodiment, the packet capturing module 212a fragments 1106 the captured data packets and/or compresses the captured data packets so that the data packets satisfy a data packet size requirement of a network protocol after the captured data packets are encapsulated 1108. For example, the captured data packets may be broken into smaller pieces that have smaller data sizes than a data size of an un-fragmented data packet. In another example, the captured data packets may be compressed so that bits are removed from the data packets, thus reducing the sizes of the data packets.

In certain embodiments, the packet capturing module 212a encapsulates 1108 the captured data packets with a packet header that includes an identifier for a second destination associated with a second computing device. In certain embodiments, the second computing device includes a monitoring agent 212, wherein the packet capturing module 212a and the monitoring agent 212 are in communication with each other over a data network. In a further embodiment, the packet capturing module 212a sends 1110 the encapsulated data packets to a packet receiving module executing on a second computing device. The packet receiving module, in certain embodiments, is configured to unencapsulate the encapsulated data packets and forward the unencapsulated data packets to a packet processing module executing on a third computing device associated with the first destination. In certain embodiments, the third computing device is the same computing device as the second computing device. In another embodiment, the third computing device may comprise a monitoring server 308.

In one embodiment, the second computing device is configured to tag the data packets for a tenant associated with the second computing device, a tag being uniquely associated with the tenant. In some embodiments, the second computing device is configured to provide data packets from multiple tenants to the packet processing module. In certain embodiments, the packet processing module comprises a single-tenant computer program product 112 executing on a third computing device, which may include one or more monitoring servers 308. In another embodiment, the packet processing module is located in the agent gateway 110, and forwards the unencapsulated data packets to one or more monitoring servers 308. And the method 1100 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for multi-tenant enabling a single-tenant computer program product, the method comprising:
tagging data associated with multiple tenants, a tag being uniquely associated with a tenant;
providing the data to a single-tenant computer program product, the data associated with the multiple tenants; and
presenting a user interface to a single tenant based on one or more tags associated with the single tenant.

2. The method of claim 1, wherein providing the data comprises forwarding the data from one or more monitoring agents to one or more monitoring servers executing the single-tenant computer program product, a monitoring agent being assigned to a monitoring server, the one or more monitoring agents associated with the multiple tenants.

3. The method of claim 2, further comprising logging an assignment of a monitoring agent to a monitoring server such that data comprising one or more tags associated with the single tenant is tracked to the assigned monitoring server.

4. The method of claim 2, wherein the data comprises one or more monitor agent event messages generated by the one or more monitoring agents.

5. The method of claim 4, further comprising translating the one or more monitor agent event messages such that the one or more monitor agent event messages are readable by the single-tenant computer program product.

6. The method of claim 2, further comprising selecting a monitoring server to process one or more monitor agent event messages based on one or more processing criteria.

7. The method of claim 1, further comprising providing data processed by the single-tenant computer program product to a pattern recognition engine, the processed data having one or more tags associated with a single tenant.

8. The method of claim 7, further comprising querying a data store associated with one or more assigned monitoring servers to locate the assigned monitoring server comprising the processed data having one or more tags associated with the single tenant.

9. The method of claim 1, further comprising organizing the data into one or more user interface components and storing data associated with the one or more user interface components in a user interface server.

10. The method of claim 9, further comprising querying a data store associated with one or more user interface servers to locate a user interface server comprising data having a tag associated with the single tenant.

11. An apparatus for multi-tenant enabling a single-tenant computer program product, the apparatus comprising:
a layer communication gateway module configured to tag data associated with multiple tenants, a tag being uniquely associated with a tenant;
a common repository module configured to provide the data to a single-tenant computer program product, the data associated with the multiple tenants; and
a user interface gateway module configured to present a user interface for the computer program product to a single tenant based on one or more tags associated with the single tenant.

12. The apparatus of claim 11, further comprising an agent gateway module configured to forward the data from one or more monitoring agents to one or more monitoring servers executing the single-tenant computer program product, a monitoring agent being assigned to a monitoring server, the one or more monitoring agents associated with the multiple tenants.

13. The apparatus of claim 12, wherein the agent gateway module further comprises an assignment logging module configured to log an assignment of a monitoring agent to a monitoring server such that data having a tag associated with the single tenant is tracked to the assigned monitoring server.

14. The apparatus of claim 12, wherein the data comprises one or more monitor agent event messages generated by one or more monitoring agents.

15. The apparatus of claim 14, wherein the agent gateway module further comprises a translation module configured to translate the one or more monitor agent event messages such that the one or more monitor agent event messages are readable by the single-tenant computer program product.

16. The apparatus of claim 12, wherein the agent gateway module further comprises a server selection module configured to select a monitoring server to process one or more monitor agent event messages based on one or more processing criteria.

17. The apparatus of claim 11, further comprising a pattern recognition module configured to provide data processed by the single-tenant computer program product to a pattern recognition engine, the processed data having one or more tags associated with the single tenant.

18. The apparatus of claim 11, wherein the user interface gateway module further comprises a data organization module configured to organize the data into one or more user interface components and storing data associated with the one or more user interface components in a user interface server.

19. A method for capturing data packets, the method comprising:
capturing, within a first computing device, data packets for the first computing device using a packet capturing module executing on the first computing device, the data packets comprising an identifier for a first destination;
encapsulating the captured data packets with a packet header comprising an identifier for a second destination associated with a second computing device; and
sending the encapsulated data packets to a packet receiving module executing on the second computing device, the packet receiving module configured to unencapsulate the encapsulated data packets and forward the unencapsulated data packets to a packet processing module executing on a third computing device associated with the first destination.

20. The method of claim 19, wherein encapsulating the captured data packets comprises at least one of fragmenting the captured data packets and compressing the captured data packets such that a size of the encapsulated data packets conforms to a data packet size requirement of a network protocol.

21. The method of claim 19, wherein the second computing device is configured to tag the data packets for a tenant associated with the second computing device, a tag being uniquely associated with the tenant.

22. The method of claim 21, wherein the second computing device is configured to provide the data packets, together with data packets from one or more additional tenants, to a packet processing module executing on a third computing device.

23. The method of claim 19, further comprising discarding one or more of the captured data packets in response to the discarded one or more of the data packets failing to satisfy one or more filtering criterion wherein the one or more filtering criterion comprise one or more of a network protocol, a data type, a data packet source, and a data packet destination.

24. The method of claim 19, wherein capturing data packets within the first computing device comprises intercepting data packets for the first computing device without accessing network equipment external to the computing first device.

25. The method of claim 19, wherein the first computing device comprises one or more virtual machines executing on the first computing device and one or more data packets are captured from within each virtual machine.
